(19) United States
(12) Patent Application Publication
(10) Pub. No.: US 2009/0071203 A1
(43) Pub. Date: Mar. 19, 2009

(54) SECURING MECHANISM FOR WINDOWS AND DOORS

(76) Inventor: Henrik L. Laursen, Roskilde (DK)

Correspondence Address: GIFFORD, KRASS, SPRINKLE,ANDERSON & CITKOWSKI, P.C, PO BOX 7021, TROY, MI, 48007-7021, US

(21) Appl. No.: 11/910,925

(22) PCT Filed: Apr. 4, 2006
(86) PCT No.: PCT/DK2006/000191

§ 371 Date: Oct. 8, 2007

Related U.S. Application Data
(60) Provisional application No. 60/741,206, filed on Dec. 1, 2005.

(30) Foreign Application Priority Data
Apr. 6, 2005 (DK) PA 2005 00480
Apr. 18, 2005 (DK) PA 2005 00559
Nov. 30, 2005 (DK) PA 2005 01695
Mar. 22, 2006 (DK) PA 2006 00403

(51) Int. Cl. E05B 65/00

(52) U.S. Cl. 70/89

(57) ABSTRACT

The present invention relates to a product and a method capable of securing a window assembly or a door assembly, so that in case the window or door, such as a pane in the window or door, is broken it is not possible to open the window or door because the securing mechanism according to the invention blocks the window or door from being opened. The invention may further provide for blocking all or a selection of windows and doors in the house, as well as for connection to alarms, such as existing alarms in the house. The invention includes an actuator actuating when a locking signal is forwarded. Said locking signal may be a radio signal, an electric or electronic signal, or a mechanical signal.

The present invention relates to a product and a method capable of securing a window assembly or a door assembly, so that in case the window or door, such as a pane in the window or door, is broken it is not possible to open the window or door because the securing mechanism according to the invention blocks the window or door from being opened. The invention may further provide for blocking all or a selection of windows and doors in the house, as well as for connection to alarms, such as existing alarms in the house.

### BACKGROUND

As a part of the door and window production doors and windows are often mounted with a lampoon. The lampoon is the locking mechanism of the door or window. The lampoon rod has connections with the outer pawls. Two different types of connections between pawls and frame exist, the “sliding pawls” and the “non sliding pawls”. “Sliding pawls” often with a grip can only be broken up by moving the pawl the opposite way. “Non sliding pawls” has a different connection between the pawl and the connection points on the stationary frame. In some, primary (US/CA) windows, the lampoon and handle or also called lock lever is placed in the stationary frame with a connection point on the openable frame, but the function with a lampoon rod is the same. The handle fitting into the lampoon at the hub of the handle are made in many different designs; however, the hub is normally a standard.

Today window handles with a built-in lock are made. Such a lock prevents a thief having broken the window glass from turning the handle and thereby entering the property. The disadvantage of this type of handles is that every time the owner leaves the house he has to make certain that all the window handles have been locked. Furthermore, every time it is desired to open a window it must first be un-locked.

Other window types are the so-called windows with window fasteners or other kinds of windows not equipped with lampoons. For these windows it is also possible, when breaking the window glass to open the window fasteners or other locking mechanism and thereby acquire admittance to the room behind the window.

It is today recommended that outer doors are equipped with a lock cylinder instead of a fastener, which normally is the standard, so that the doors may be locked from the inside with a key. Thereby it is secured that the owner brings the key with him after having locked the door as usual. In case a thief breaks the glass in the door it is not possible to open the door due to lack of the fastener.

### SUMMARY OF THE PRESENT INVENTION

The present invention relates to a novel mechanism for securing windows and doors by incorporating into the window or door a locking mechanism being activated if a signal is forwarded to an actuator actuating the locking mechanism.

The actuator may be actuated in a variety of scenarios, such as when the door or window breaks or is attempted broken, such as if the glass of the door or window breaks or is attempted broken, when a neighbouring door or window is broken or attempted broken, or by pre-locking the door or window when leaving the house through a central system. The latter scenario also gives the user the opportunity to get information if a window or door is not closed when turning on the system to an active stage.

Accordingly, the present invention relates to a burglar-proof window assembly or door assembly comprising at least one frame, such as a window assembly or a door assembly comprising at least one pane surrounded by said at least one frame, said frame comprising at least one securing unit, said securing unit comprising
an actuator, said actuator actuating when a signal is forwarded to the actuator,
locking means capable of shifting between at least two positions, an un-locked position and a locked position,
wherein the locking means is arranged so that when the actuator is actuated then the actuator causes the locking means to shift from an un-locked position to the locked position and the window or door is blocked from being opened.

Thus, in one embodiment the invention relates to a burglar-proof window assembly or door assembly comprising at least one frame, such as a window assembly or a door assembly comprising at least one pane surrounded by said at least one frame, said frame comprising at least one securing unit, said securing unit comprising
an actuator, said actuator actuating when the door or the window, such as the pane in the frame, is broken or attempted broken,
locking means capable of shifting between at least two positions, an un-locked position and a locked position,
wherein the locking means is arranged so that when the actuator is actuated then the actuator causes the locking means to shift from an un-locked position to the locked position and the window or door is blocked from being opened.

In another embodiment the invention relates to a burglar-proof window assembly or door assembly comprising at least one frame, such as a window assembly or a door assembly comprising at least one pane surrounded by said at least one frame, said frame comprising at least one securing unit, said securing unit comprising
an actuator, said actuator actuating when a signal from a central system is forwarded,
locking means capable of shifting between at least two positions, an un-locked position and a locked position,
wherein the locking means is arranged so that when the actuator is actuated then the actuator causes the locking means to shift from an un-locked position to the locked position and the window or door is blocked from being opened.

The central system may be a pre-locking system, such as a system activated when the main entrance door is locked, or activated when an alarm system is set, or when a keyboard outside the front door is set. In another embodiment the central system may be activated if one window or door in the house is broken or attempted broken.

By the term window or door assembly is meant a window or a door as such as well as several windows adjacent each other or a door and one or more adjacent windows. I.e. by the term assembly is meant that the windows or door/windows are so close that breaking the window pane in one could allow entrance to the closing mechanism of another window or door.

The invention provides for a mechanical solution as well as electromechanical solution. The invention also provides means for combining the securing unit with a central unit whereby it is possible to combine the securing unit from one window or door with the securing units from other windows or doors in the house, so that all windows and/or doors may be blocked should one window or door be broken or attempted broken. In the solution where a pre-locked of all windows and doors is made, the user controls a central unit in the central system. The central unit can also give the user information if a window or door is not closed when turning on the system to an active stage.

### DRAWINGS

FIG. 1a shows a window with one pane having a lampoon rod, FIG. 1b shows a window with bars and four panes having a lampoon rod, and FIG. 1c shows a window with one pane and a fastener, and FIG. 1d shows a window assembly with one openable window and a neighbour window.

FIG. 2a shows a lampoon and FIG. 2b shows the lampoon along section B-B of the lampoon in FIG. 2a.

FIG. 3a shows a lampoon comprising a securing unit according to the invention, FIG. 3b shows the lampoon along section C-C, and FIG. 3c shows the lampoon along section D-D.

FIG. 4a shows a securing unit according to the invention wherein a slidable rod may be received in a lampoon rod, FIG. 4b shows the securing unit along section C-C, and FIG. 4c shows the securing unit along section D-D.

FIG. 5a shows a securing unit according to the invention wherein a slidable rod may be received in a stationary window frame, FIG. 5b shows the securing unit along section C-C, and FIG. 5c shows the securing unit along section D-D.

FIG. 6 shows a plate for securing recess in the stationary window frame of FIG. 5.

FIG. 7 shows a securing unit for use in a window assembly as shown in FIG. 1d.

FIG. 8 shows an auxiliary spring adjacent a unit house.

FIG. 9a shows a security unit arranged in relation to a hub in a lampoon, and FIG. 9b shows the security unit seen along section C-C of FIG. 9a.

FIG. 10 shows actuator designed as a motor-gear-lock with detector (43) consisting of a DC-motor 44 with a gearwheel 45 fastened to the motor shaft 46. The gear-wheel 45 drives 3 similar gearwheels 47a, 47b and 47c, all free to turn and not fastened to the motor shaft 46 and the gear shaft 48. The last gearwheel 49 is driven by the small gearwheel 47c and is also free to turn and not fastened to the motor shaft 46. The blocking rod 50 that is a part of gearwheel 49 can be moved in and out of the receiving means 18 to a locked or unlocked position. In locked position a movement of the lampoon rod 1 will result in a movement of the blocking rod 50 in direction M. The blocking rod 50 will then turn on the micro-switch 52.

FIG. 10a, seen from section A-A, shows the small gearwheel of 47c and gearwheel 49 with the blocking rod 50 in a locked and unlocked position into the receiving means 18 in the lampoon rod 1.

FIG. 11 shows a securing unit 11 according to the invention arranged in a window frame 10. The lampoon comprises lampoon rod 1, and non sliding pawls 2.

FIG. 11a shows securing unit 11 according to the invention arranged in a window frame 10 comprising a lampoon rod 1, seen from section B-B. The figure further shows the LED 31, the battery power supply 33, and the unit house 32. The electronic circuit 34 consisting of the radio transmitter/receiver 35 and the microprocessor 36 is also shown.

FIG. 11b shows securing unit 11 according to the invention arranged in a window frame 10 comprising a lampoon rod 1, seen from section C-C. The motor-gear-lock with detector 43 in unlocked position, the blocking rod 50 and the receiving means 18 are also shown.

FIG. 11c shows securing unit 11 according to the invention arranged in a window frame 10 comprising a lampoon rod 1, seen from section C-C. The motor-gear-lock with detector 43 in locked position, the blocking rod 50 and the receiving means 18 are shown. A crowbar 42 is also shown.

FIG. 11d shows securing unit 11 according to the invention arranged in a window frame 10 comprising a lampoon rod 1, seen from section A-A. The piezoelectric glass break detector 41 is mounted on the pane 12.

FIG. 11e shows securing unit 11 according to the invention arranged in a window frame 10 comprising a lampoon rod 1, the pawl 2 and the closing points 38, seen from section D-D (arrow shows the pawls locking direction).

FIG. 12 shows a securing unit 11 according to the invention arranged in a window frame 10. The window is based on a handle 14 and a fastener 15 (not shown)

FIG. 12a shows securing unit 11 according to the invention arranged in a window frame 10 comprising the fastener method, seen from section B-B. The figure further shows the LED 31, the battery power supply 33, and the unit house 32. The electronic circuit 34 consisting of the radio transmitter/receiver 35 and the microprocessor 36 is also shown.

FIG. 12b shows securing unit 11 according to the invention arranged in a window frame 10 comprising the fastener method, seen from section C-C. The motor-gear-lock with detector 43 in unlocked position, the blocking rod 50 and the reinforcing plate 22 are also shown.

FIG. 12c shows securing unit 11 according to the invention arranged in a window frame 10 comprising the fastener method, seen from section C-C. The motor-gear-lock with detector 43 in locked position, the blocking rod 50 and the reinforcing plate 22 are also shown.

FIG. 12d shows securing unit 11 according to the invention arranged in a window frame 10 comprising the fastener method, seen from section A-A. The piezoelectric glass break detector 41 is mounted on the pane 12.

FIG. 12e shows securing unit 11 according to the invention arranged in a window frame 10 comprising the fastener method, seen from section D-D. The handle 14, the fastener 15, and a crowbar 42 are also shown.

FIG. 13 shows a securing unit 11 according to the invention arranged on a window frame 10. The lampoon comprises lampoon rod 1 and non sliding pawls 2.

FIG. 13a shows securing unit 11 according to the invention arranged on a window frame 10 comprising a lampoon rod 1, seen from section B-B. The figure further shows the LED 31, the battery power supply 33, and the unit house 32. The electronic circuit 34 consisting of the radio transmitter/receiver 35 and the microprocessor 36 is also shown.

FIG. 13b shows securing unit 11 according to the invention arranged on a window frame 10 comprising a lampoon rod 1, seen from section C-C. The motor-gear-lock with detector 43 in unlocked position, the blocking rod 50 and the reinforcing plate 22 are also shown.

FIG. 13c shows securing unit 11 according to the invention arranged on a window frame 10 comprising a lampoon rod 1, seen from section C-C. The motor-gear-lock with detector 43 in locked position, the blocking rod 50 and the reinforcing plate 22, as well as a crowbar 42 are also shown.

FIG. 13d shows securing unit 11 according to the invention arranged on a window frame 10 comprising a lampoon rod 1, seen from section A-A. The piezoelectric glass break detector 41 is mounted on the pane 12.

FIG. 13e shows securing unit 11 according to the invention arranged on a window frame 10 comprising a lampoon rod 1, the pawl 2 and the closing points 38, and the reinforcing plate 22, seen from section D-D (arrow shows the pawls locking direction).

FIG. 14 shows a securing unit 11 according to the invention arranged on a window frame 10. The window is based on a handle 14 and a fastener 15 (not shown).

FIG. 14a shows securing unit 11 according to the invention arranged on a window frame 10 comprising the fastener method, seen from section B-B. The figure further shows the LED 31, the battery power supply 33, and the unit house 32. The electronic circuit 34 consisting of the radio transmitter/receiver 35 and the microprocessor 36 is also shown.

FIG. 14b shows securing unit 11 according to the invention arranged on a window frame 10 comprising the fastener method, seen from section C-C. The motor-gear-lock with detector 43 in unlocked position, the blocking rod 50 and the reinforcing plate 22 are also shown.

FIG. 14c shows securing unit 11 according to the invention arranged on a window frame 10 comprising the fastener method, seen from section C-C. The motor-gear-lock with detector 43 in locked position, the blocking rod 50 and the reinforcing plate 22 are also shown.

FIG. 14d shows securing unit 11 according to the invention arranged on a window frame 10 comprising the fastener method, seen from section A-A. The piezoelectric glass break detector 41 is mounted on the pane 12.

FIG. 14e shows securing unit 11 according to the invention arranged on a window frame 10 comprising the fastener method, seen from section D-D. Furthermore, the figure shows the handle 14 and the fastener 15. A crowbar 42 is also shown.

FIG. 15 shows a securing unit 11 according to the invention arranged in a window frame 10. The lampoon comprises lampoon rod 1 and sliding pawls 2. A screwdriver 51 is also shown (arrow shows the pawls locking direction).

FIG. 15a shows securing unit 11 according to the invention arranged in a window frame 10 comprising a lampoon rod 1, seen from section B-B. The figure further shows the LED 31, the battery power supply 33, and the unit house 32. The electronic circuit 34 consisting of the radio transmitter/receiver 35 and the microprocessor 36 is also shown.

FIG. 15b shows securing unit 11 according to the invention arranged in a window frame 10 comprising a lampoon rod 1, seen from section C-C. The motor-gear-lock with detector 43 in unlocked position, the blocking rod 50 and the receiving means 18 are also shown.

FIG. 15c shows securing unit 11 according to the invention arranged in a window frame 10 comprising a lampoon rod 1, seen from section C-C. The motor-gear-lock with detector 43 in locked position, the blocking rod 50 and the receiving means 18 are also shown.

FIG. 15d shows securing unit 11 according to the invention arranged in a window frame 10 comprising a lampoon rod 1, seen from section A-A. The piezoelectric glass break detector 41 is mounted on the pane 12.

FIG. 15e shows securing unit 11 according to the invention arranged in a window frame 10 comprising a lampoon rod 1, the pawl 2 and the closing points 38, seen from section D-D. A part of the screwdriver 51 is also shown.

FIG. 16 shows a securing unit 11 according to the invention arranged on window frame 10. The lampoon comprises lampoon rod 1 and sliding pawls 2. A screwdriver 51 is also shown (arrow shows the pawls locking direction).

FIG. 16a shows securing unit 11 according to the invention arranged on a window frame 10 comprising a lampoon rod 1, seen from section B-B. The figure further shows the LED 31, the battery power supply 33, and the unit house 32. The electronic circuit 34 consisting of the radio transmitter/receiver 35 and the microprocessor 36 is also shown.

FIG. 16b shows securing unit 11 according to the invention arranged on a window frame 10 comprising a lampoon rod 1, seen from section C-C. The motor-gear-lock with detector 43 in unlocked position, the blocking rod 50 and the reinforcing plate 22 are also shown.

FIG. 16c shows securing unit 11 according to the invention arranged on a window frame 10 comprising a lampoon rod 1, seen from section C-C. The motor-gear-lock with detector 43 in locked position, the blocking rod 50 and the reinforcing plate 22 are also shown.

FIG. 16d shows securing unit 11 according to the invention arranged on a window frame 10 comprising a lampoon rod 1, seen from section A-A. The piezoelectric glass break detector 41 is mounted on the pane 12.

FIG. 16e shows securing unit 11 according to the invention arranged on a window frame 10 comprising a lampoon rod 1, the pawl 2 and the closing points 38, seen from section D-D. A part of the screwdriver 51 is also shown.

### LIST OF REFERENCE SIGNS

1 lampoon rod

2 pawl

3 hub

4 lampoon side plate

5 locking means

6 spring

7 recess

8 pane edge

9 plate

10 window frame

11 securing unit

12 pane

13 bar

14 handle

15 fastener

16 stationary frame

17 neighbouring window

18 receiving means

19 covering plate

20 screw

21 guiding plate

22 reinforcing plate

23 intermediary locking means

24 unit house

25 auxiliary actuator

27 tube

29 tube for neighbouring window

30 plate

31 LED (light-emitting diode)

32 unit house (later mounted)

33 battery power supply

34 electronic circuit

35 radio transmitter/receiver

36 microprocessor

37 electronic contact units

38 closing points

39 electromechanical actuator

40 metal rod

41 piezoelectric glass break detector

42 crowbar

43 motor-gear-lock with detector

44 DC-motor

45 gearwheel

46 motor shaft

47 a-c gearwheel

48 gearshaft

49 gearwheel

50 blocking rod

51 screwdriver

52 micro-switch

### DETAILED DESCRIPTION OF THE INVENTION

The present invention relates to a securing system for windows and doors, by which a window or door may be locked so that it cannot be opened by its usual opening mechanisms. The windows or doors may either be pre-locked when the house is left or locked if an attempt to break into the house through a door or a window is made. By the term “pre-locked” is meant that the doors and windows in question are locked according to the invention before any attempts to intrude have been performed, such as when the house is left. The invention relies on automatic locking of the windows and doors, when an actuator is actuated. Thereby the user is not forced to lock every window or door manually before leaving the house to secure the house.

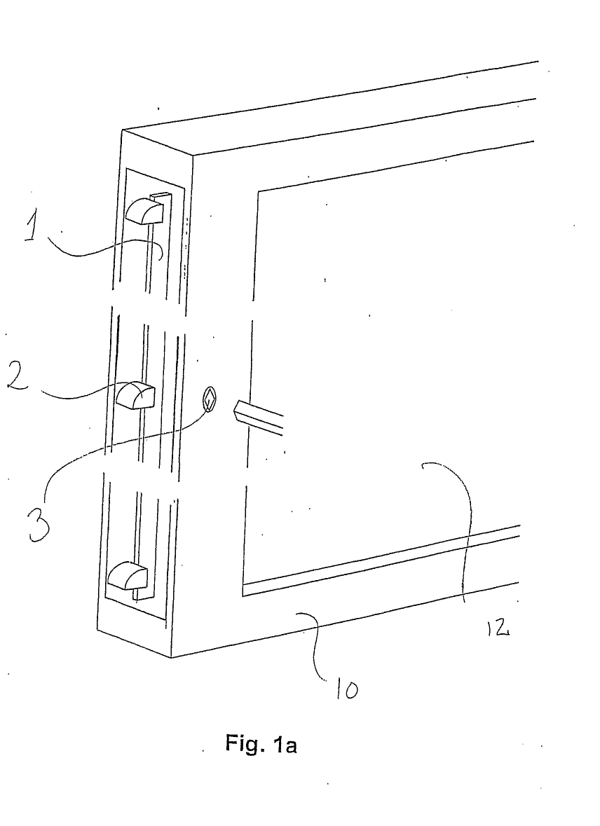

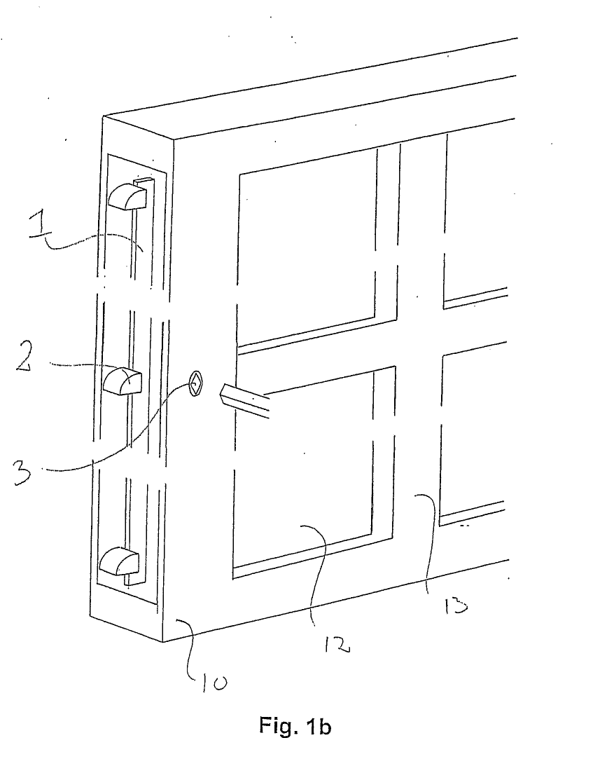

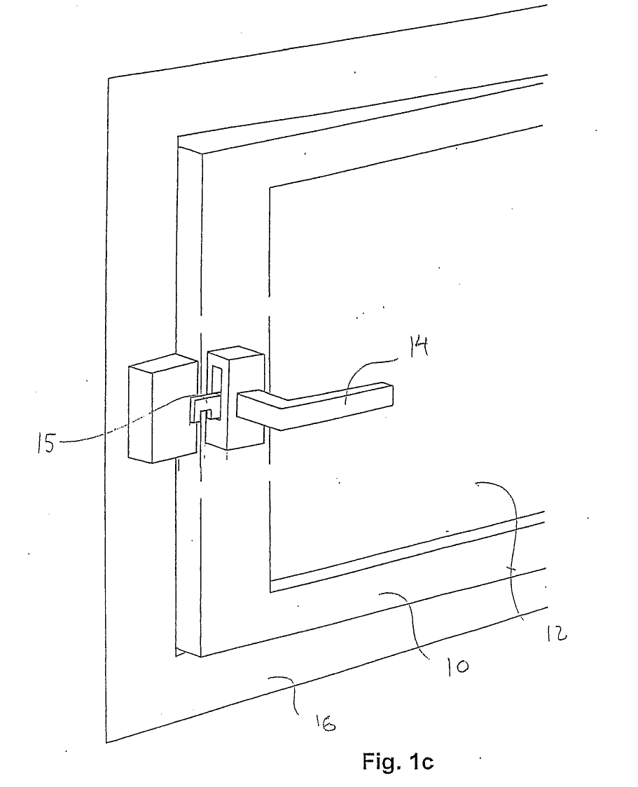

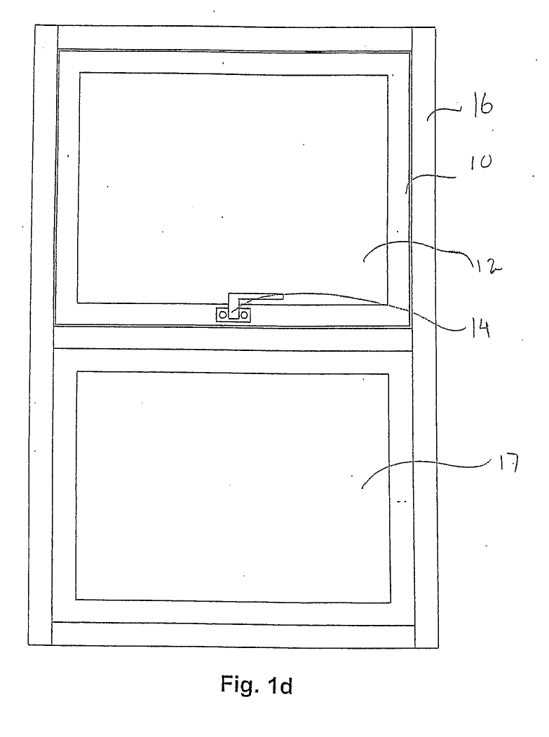

The invention may be used in any type of window or door, such as a window or door having at least one pane being surrounded by a frame, such as the windows shown in FIG. 1a and FIG. 1b, or a door without a window. Accordingly, the invention may be used in a window or a door equipped with a lampoon and a turnable fastener wherein the invention secures that the fastener cannot be turned when the actuator according to the invention has been actuated thereby causing the window or door to be locked. The invention may also be used in a window or a door having any other type of closing mechanism, such as the window shown in FIG. 1c, wherein the securing unit secures that the window or door is blocked from being opened when the actuator is actuated. Furthermore, the invention may be used in a window assembly as shown in FIG. 1d, wherein the breakage of a neighbouring pane leads to actuating the actuator thereby blocking the window from being opened. Thus, the present invention may be used in connection with any types of window or door assemblies, independent of the amount of window panes, and window bars in the window or door.

In one embodiment the actuator is actuated by a signal from a central system having a central control unit. Thereby it is possible to pre-lock the windows and doors for example when the main entrance door is locked, or when a keyboard outside the front door is set or by activating the central control unit, or in another embodiment by actuating the actuator when the alarm system is activated.

In another embodiment the idea behind the invention is to prevent the openable window or door from being opened by use of the normal closing mechanism of the window or door if the window or door, such as a pane in said window or door, or a neighbouring window or door, is broken. Furthermore, the invention provides means for preventing the openable window or door from being opened by use of the normal closing mechanism of the window or door if the window or door, such as a pane in said window or door, or a neighbouring window or door, if the window or door is attempted broken, such as the situation wherein an intruder attempts to break the frame using a crowbar, screwdriver or the like. By the term “attempted broken” is meant that attempts are made to either break the door or window material, such as breaking the plate or frame of the door, or pane or frame of the window. This is accomplished by introducing at least one securing unit in the frame of the window or door.

The securing unit comprises
an actuator, said actuator actuating when a locking signal is forwarded,
locking means capable of shifting between at least two positions, an un-locked position and a locked position,
wherein the locking means is arranged so that when the actuator is actuated then the actuator causes the locking means to shift from an un-locked position to the locked position and the window or door is blocked from being opened.

A “locking signal” may be any signal causing the actuator to actuate. In one embodiment, the locking signal is a mechanical signal, such as described below in relation to some of the actuators. In another embodiment, the locking signal is a radio signal forwarded to the actuator from for example a central computer. In yet another embodiment, the locking signal is an electric or electronic signal.

The securing unit may be arranged in the window or door frame, such as a frame surrounding a pane. It may be arranged in any suitable position; however, it is preferred that at least one securing unit is arranged opposite the hinge of the window in order to provide the best effect. In particular if a solely mechanical solution is applied, a window may be provided with more than one securing unit. The latter is particularly relevant if the window is provided with more than one pane. It may be desired that the window is provided with at least one securing unit per window pane, or at least for each of the panes close to the closing mechanism of the window or door.

In case the window is provided with a lampoon unit it may be appropriate to arrange the securing unit in or adjacent the lampoon unit. Thereby the production of the window may be facilitated.

The actuator is arranged in the securing unit in a manner whereby the actuator is deactivated as long as the window or door is intact. Depending on the nature of the actuator, the actuator is activated when a window or a door, such as a pane in the window or door, is broken or attempted broken.

The present invention includes a several different actuators as described in the following. In general the actuators may be categorised as either purely mechanical or as a combination of a mechanical and an electronic actuators, i.e. electro-mechanical actuators.

In the following mechanical actuators are described. A mechanical actuator is characterised by mechanical parts being activated if the frame or a pane in the frame is broken or attempted broken.

In one embodiment the pressure of the pane in the window frame maintains the actuator deactivated. Once the pressure of the pane decreases if for example the window glass is broken, then the actuator actuates causing the window or door to be blocked.

The actuator is preferably capable of actuating by moving the window pane remains, for example by turning, when the pressure of the window decreases. In one embodiment, the actuator is capable of actuating when the window pane remains are moved less than 1.5 cm, more preferably less than 1.0 cm. In a preferred embodiment, the actuator is a spring capable of turning if the pressure force of the spring moves the window pane remains at least 2 mm, such as at least 4 mm.

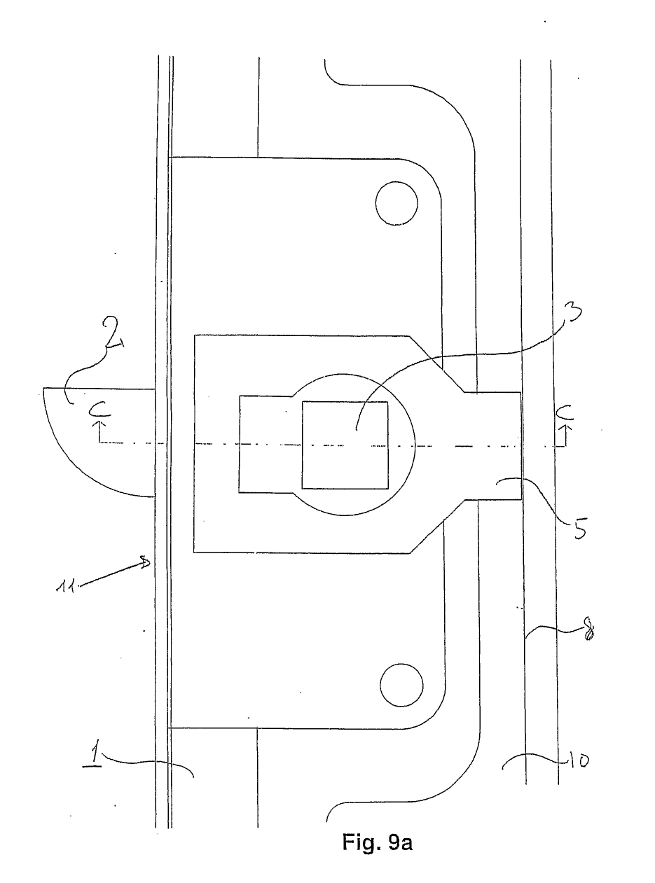

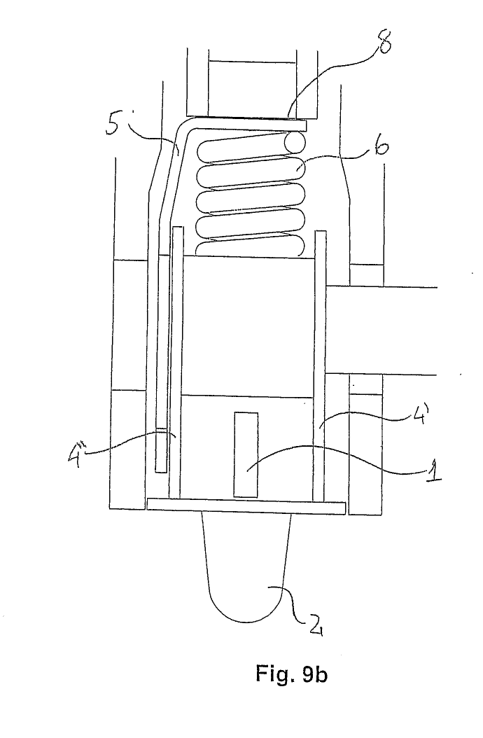

In another embodiment the actuator is a spring capable of dragging the locking means into a locking position, such as a locking position around the hub. In this embodiment it is preferred that the actuator is capable of moving the window pane remains at least 2 mm, more preferred at least 4 mm, such as at least 6 mm. In this embodiment, the locking means may be integrated with the actuator or separate therefrom as shown in FIG. 9.

In addition to the actuator discussed above the window or door assembly may comprise an auxiliary actuator, such as a spring, inserted near the actuator. Thereby the auxiliary actuator may assist in moving the window pane remains so that the actuator is capable of actuating. The auxiliary actuator may also be solely responsible for moving the window pane remains to allow the actuator to actuate.

The actuator may press directly against the pane or indirectly using a pressure absorbing material between the pane and the actuator. This is particular relevant if the window is a double-glazed window or a sealed unit, wherein the pressure of the actuator preferably should be against all the panes. Furthermore, such a pressure absorbing plate may also compensate for different distances between the actuator and the pane edge in the various window types. A plate of absorbing material must be sufficiently small so that the actuator in fact is capable of actuating when the pane is broken, that is the plate must not distribute the pressure of the actuator and/or auxiliary actuator to such a degree that the actuator cannot actuate.

In yet another embodiment the actuator is activated when an original pressure between two panes in a double-glazed unit or a sealed unit is neutralized towards atmospheric pressure due to breakage of at least one of the two panes. If a pane of a sealed window is broken then the pressure between the two panes decreases if the original pressure is an overpressure or increases if the original pressure is a vacuum.

In the following electromechanical actuators are described. Electromechanical actuators are preferably constructed so that breaking the window or door, such as breaking a pane therein, causes a signal to be transmitted to the actuator. The actuator may then cause the locking means to shift position by direct contact with the locking means as described above in relation to the purely mechanical actuator, or the actuator may cause the locking means to shift position by transmitting a signal to the locking means. Thus, in a preferred embodiment the actuator comprises a microprocessor and a radio transmitter/receiver that can transmit and receive radio signals. The actuator is preferably power supplied from a battery, although other means for supplying power may be used, such as being connected to the power supply of the house. If battery supplied it is preferred that an alarm is connected to the actuator, whereby the alarm signals if the battery power is low.

Furthermore, in relation to the electromechanical actuator the actuator or another part of the system may be provided with a part visible from the outside, such as a LED flashing (known from car alarms). Thereby any intruder is warned about the system, and this may in itself be preventive.

In one embodiment the electromechanical actuator is activated by an acoustic sensor capable of reacting to breaking of the window or door, such as capable of reacting to the breaking of glass. The acoustic sensor, such as an acoustic glass break detector, recognises the sound picture of glass breaking or wood breaking and activates the actuator upon detecting the signal. The actuator then activates, for example by transmitting a signal to the locking means whereby the locking means shifts position and block the opening-function.

The electromechanical actuator may also be activated by a piezoelectric glass break detector positioned on the pane. The piezoelectric glass break detector will produce an electrical power. The electrical power is registered by the microprocessor of the actuator causing the electromechanical actuator to block the opening-function.

The electromechanical actuator may also be activated by a contact unit capable of being short-circuited if pressure is applied to the contact unit. Such an actuator may be arranged in the frame at positions wherein it is likely that pressure from for example a crowbar would be applied. For example the contact unit may be applied close to the locking means or hinging means.

In cases where the user activate and deactivate the security system the contact unit could be a simple on/off contact that may detect an attempt of opening. The simple contact could also give the user information about an opened window when turning on the security system.

Furthermore, the securing unit may comprise a combination of two or more of the electromechanical actuators discussed above. For example the window or door may be equipped with both the acoustic sensor as well as the contact unit.

The energy for the electromechanical actuator may be provided by coupling the actuator to the conventional electrical supply in the house. However this requires cabling to every door and window. In a preferred embodiment the system is battery driven, at least for the parts of the security system being arranged in or near the windows and doors.

The actuator may comprise any suitable transmitter, such as a radio transmitter/receiver, and a microprocessor, such as of manufacture from a ZigBee Alliance based system e.g. Chipcon, Freescale, Zensys and Nordic Semiconductor. The ZigBee standard has been developed by the ZigBee Alliance, an association of companies working together to enable reliable, low cost, low-power, wireless networking based on an open global standard.

One of the main advantages in a ZigBee based system is the low power use of the radio and microprocessor that is build as one unit (SOC—System on a chip).

The transmitter is preferably capable of entering a “sleep mode” in order to save energy, which in particular is relevant when the transmitter is battery driven. In order to be able to function, the transmitter itself preferably enters “active mode” at regular intervals.

For example, the transmitter may “wake up” from sleep mode for a very short time, e.g. 2 msec (0,002 sec) to monitor whether a signal is being forwarded to the transmitter. The frequency of the “wake up” may vary, but is usually in the order of a few seconds, such as 2 seconds. In general, the sleep mode periods are so short that the user does not recognise them.

When the radio transmitter listens only 2 msec for each 2 sec the radio is only active and listening for 3.6 sec per hour.

The listening period can be different in different modes for a product. When the window and door system is in a deactive stage, when the owner is at home, the listening period could be each minute. That will result in an active listen time for only 0.12 sec per hour.

Such a transmitter having sleep mode and active mode with regular “wake up” periods is very energy efficient which is important, in particular is the system is battery driven. In the following a calculation of the energy needed is provided:

The calculation is based on a ZigBee transmitter and microprocessor.

If we conclude that the system is in active mode 12 hours per day and deactive mode also 12 hours per day, then the radio only uses listening “power” (0.12 sec×12 hour+3.6 sec×12 hour)=44.64 sec each day. Using e.g TI/chipcon 2430 chipset (System On a Chip) the radio in listening mode uses only 25 mA (0.025A). Each day it will use only 0.31 mA (0.00031A). The microprocessor has to run all the time and uses 0.6 uA (0.0000006A). In total the energy requirement will be 0.015 uA per day. On a power capacity at 2100 mA that is 75% off a standard AA battery with min. 2800 mA full capacity the system can be driven for 18.5 years using the same battery.

In a preferred embodiment the electromechanical actuator is constructed as a motor-gear-lock with detector which gives the opportunity to make a pre-locking activated via a keyboard or via the existing alarm system and still being powered from batteries. Calculations of the power use of this type of actuator using one embodiment of motors shows that it is possible to make 7300 locking or unlocking on each 1000 mAh power use. A standard type 1.5 v, M-battery has between 2800-3200 mAh total power. With 7300 lock-actions on 1000 mAh it is possible to make 5 lock-actions each day in 4 years. In combination with the new ZigBee based, low power use, radio chips a battery life time on 4-5 years on 2×AA batteries is possible. Using another motor it is possible to make 11000 locking or unlocking on each 1000 mAh power use. A standard type 1.5 v, M-battery has between 2800-3200 mAh total power. With 11000 lock-actions on 1000 mAh it is possible to make 5 lock-actions each day in 6 years. In combination with the new ZigBee based, low power use, radio chips a battery life time on 5-6 years on 2×AA batteries is possible.

Furthermore, the actuator may have a detector incorporated, for example in the form of a micro-switch. In one embodiment when conducting a pre-locking and having a micro-switch integrated into the actuator it is possible to detect a movement of the lampoon rod and furthermore act on such detection, for example by causing an alarm system to start. In all types of lampoon systems with a moving rod between the handle and the closing points a movement of the rod when door or window is in a locked position will result in an activation of the micro-switch in the actuator.

Additionally, the securing unit may comprise a securing unit having both a mechanical actuator and an electromechanical actuator if appropriate.

The actuator, independent of its shape or mechanism, causes locking means capable of shifting between at least two positions, an un-locked position and a locked position, to shift from the un-locked position to the locked position thereby causing the door or window to be blocked from being opened. In one embodiment the actuator is a spring, and one end of said spring rotates during actuation whereby said one end presses the locking means into the receiving means. By the term “un-locked position” of the locking means is meant the position of the locking means of the securing unit when the actuator is deactivated by the pressure of the pane. Contrary to this, the term “locked position” means the position of the locking means in the receiving means leading to the window or door being blocked from being opened.

The locking means may attain any suitable shape. In one embodiment the locking means is separate from the actuator, such as a slidable rod or cramp arranged so that the actuator when actuating causes the rod or cramp to slide into the locked position. In a preferred embodiment the actuator also causes the slidable rod or cramp to stay in the locked position. The actuator and the slidable rod or cramp may be arranged in a unit house, and said house may be positioned as described above with respect to the securing unit. The slidable rod is preferably arranged between at least two guiding plates for positioning the rod.

In another embodiment the locking means is integrated with the actuator, for example as a rod connected to one end of the actuator. When the actuator actuates the rod is then turned into the locked position, and preferably kept in that position.

The window or door assembly may be provided with receiving means capable of receiving the locking means in the locked position of said locking means. The receiving means are in one embodiment positioned in the stationary frame of the window or door, i.e. the frame part being stationary when the window or door opens. The receiving means may be at least one recess capable of receiving the locking means. The recess may be arranged in the frame, or a reinforced part of the frame, such as reinforced with at least one metal plate. In one embodiment the recess is defined by recess plates.

If the window or door is provided with a lampoon and lampoon rod, the recess may also be arranged in the lampoon rod. Thus, if the window or door is provided with a turnable fastener wherein a lampoon unit is connected to a lampoon rod, said lampoon rod being arranged along one of the edges of the pane, then the receiving means may be a recess arranged in the lampoon rod.

In case of neighbouring windows, the receiving means may be arranged in the openable window frame of the openable window, such as depicted in FIG. 7.

As described in relation to the drawings the securing unit according to the invention may be arranged in the window or door at any appropriate time. In one embodiment the securing unit is integrated with the window or door during production of the window or door. In another embodiment the securing unit may be mounted onto or into the window or door after production of the window or door. Thereby the house owner is capable of securing existing windows or doors in his house even though the windows or doors have not be equipped with the securing units during production.

In one embodiment the system also comprises means for locking other windows/doors than the one being broken or attempted broken. Thereby breaking one window or door or pane therein not only activates the actuator of the window or door being broken, but also the other windows or doors of the house. In particular if the actuator is activated through a signal being transmitted from a detector, such as a glass break detector or a contact unit, the signal may be transmitted to all relevant actuators of the house. Thus, if the intruder gains access to the house through the window or door being broken, then any other escape routes are blocked.

The system according to the invention may further provide opportunities so that the security system may be connected to an alarm, such as an acoustic alarm, for example by connecting the security unit to an existing alarm and security system. Using the pre-locking method the pre-locking can be activated turning on an existing alarm and security system or via a keyboard outside the front door.

In a further embodiment the system may also be connected to a smoke alarm. In case of fire and smoke the smoke alarm may transmit a signal to the actuator thereby inhibiting the actuator from activating the locking means. This is primarily a safety issue so that escape routes in case of fire cannot be blocked.

### DETAILED DESCRIPTION OF THE DRAWINGS

FIG. 2a shows a conventional lampoon having a lampoon rod 1 and a pawl 2. The lampoon is arranged in the window frame 10, adjacent the pane edge 8. The lampoon comprises a hub 3 for receiving a handle. FIG. 2b shows the lampoon seen from a view along section B-B of the lampoon in FIG. 2a wherein the lampoon rod 1 and the pawl 2 is visible in relation to the hub 3.

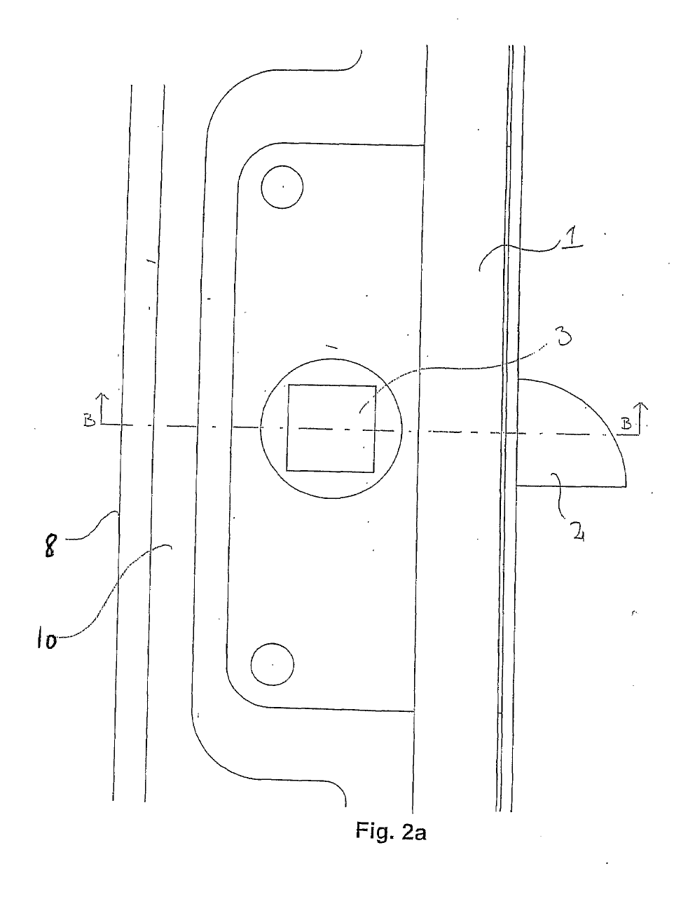

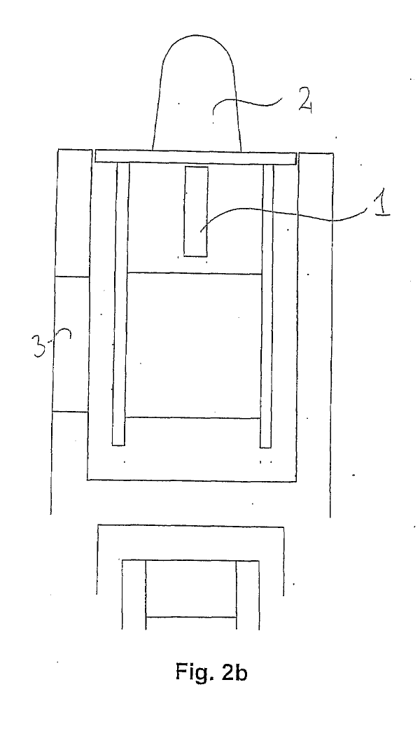

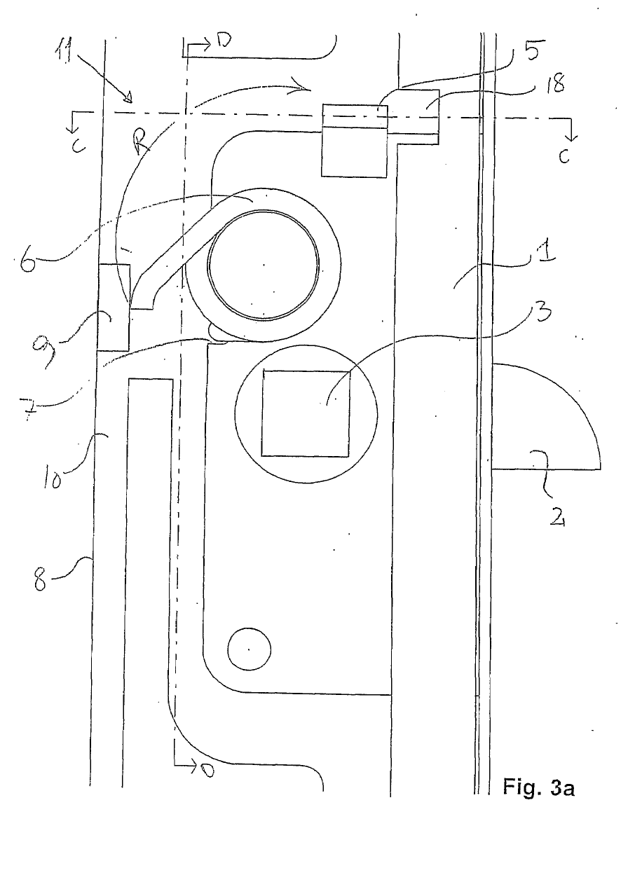

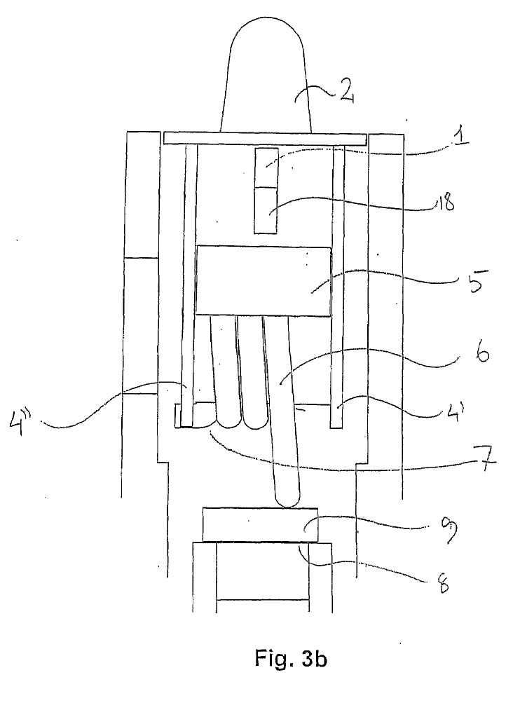

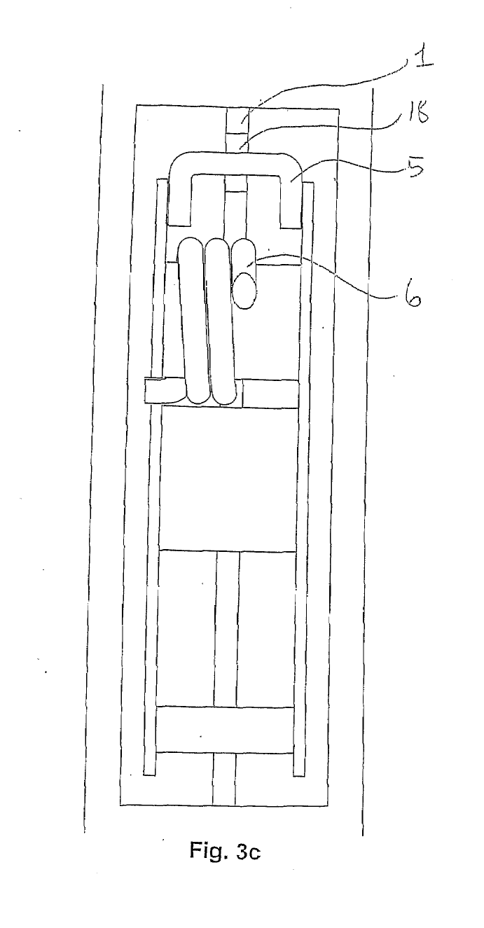

FIG. 3a shows a securing unit 11 according to the invention arranged in a lampoon in the window frame 10. The lampoon comprises lampoon rod 1, pawl 2 as well as hub 3. The actuator 6 is a spring positioned in recess 7 so that it exerts a pressure against the pane edge 8. Between the actuator 6 and the pane edge 8, a plate 9 is positioned to protect the pane and distribute the pressure from the actuator 6 along the pane edge 8. The plate 9 is preferably made from a plastic material. The window further comprises a lampoon and lampoon rod 1. If the window pane is broken then the pane cannot exert a pressure against the actuator 6, whereby the actuator 6 forces the pane edge 8 to move so that the actuator 6 actuates rotating along arrow R thereby forcing the cramp 5 from its unlocked position to its locked position in the recess 18 in the lampoon rod 1. When the cramp 5 is positioned in the locked position, the window is blocked from being opened since the lampoon rod cannot be moved.

FIG. 3b shows the securing unit seen from a section C-C, and FIG. 3c shows the securing unit seen from section D-D both in the direction of the arrows in FIG. 3a.

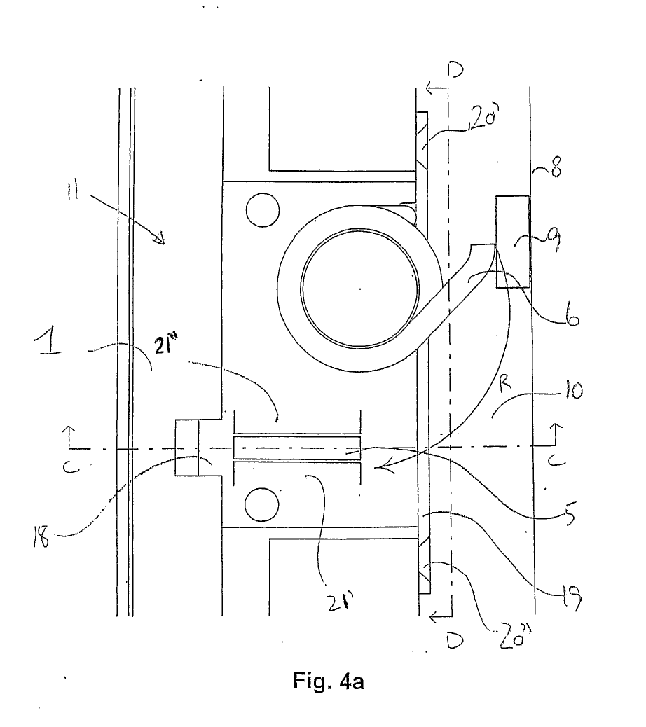

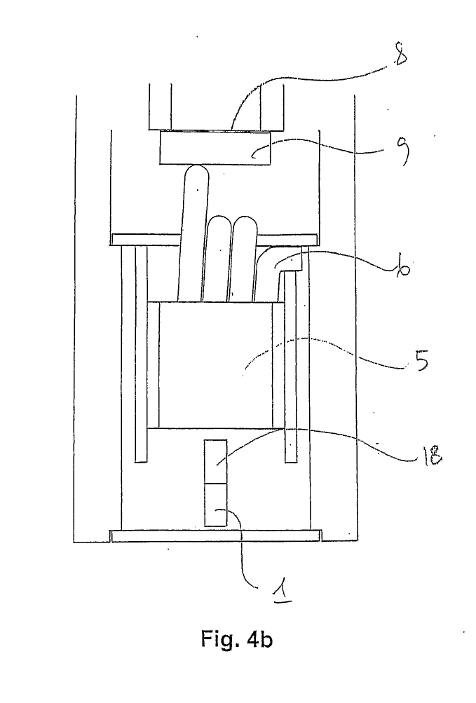

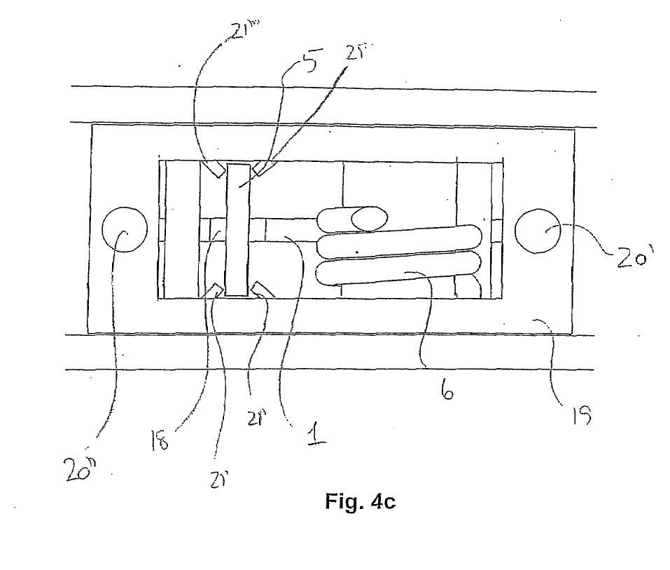

FIG. 4a shows a securing unit 11 according to the invention arranged in the window frame 10. The securing unit 11 is positioned behind a cover plate 19 attached with screws 20′, 20″. The actuator 6 is a spring positioned so that it exerts a pressure against the pane edge 8. Between the actuator 6 and the pane edge 8, a plate 9 is positioned to protect the pane and distribute the pressure from the actuator 6 along the pane edge 8. The plate 9 is preferably made from a plastic material. The window further comprises a lampoon and lampoon rod 1. If the window pane is broken then the pane cannot exert a pressure against the actuator 6, whereby the actuator 6 forces the pane edge 8 to move so that the actuator 6 actuates rotating along arrow R thereby forcing the slidable rod 5 from its unlocked position between guiding plates 21′, 21″ to it's locked position in the recess 18 in the lampoon rod 1. When the slidable rod 5 is positioned in the locked position the window is blocked from being opened since the lampoon rod cannot be moved.

FIG. 4b shows the securing unit seen from a section C-C, and FIG. 4c shows the securing unit seen from section D-D both in the direction of the arrows in FIG. 4a.

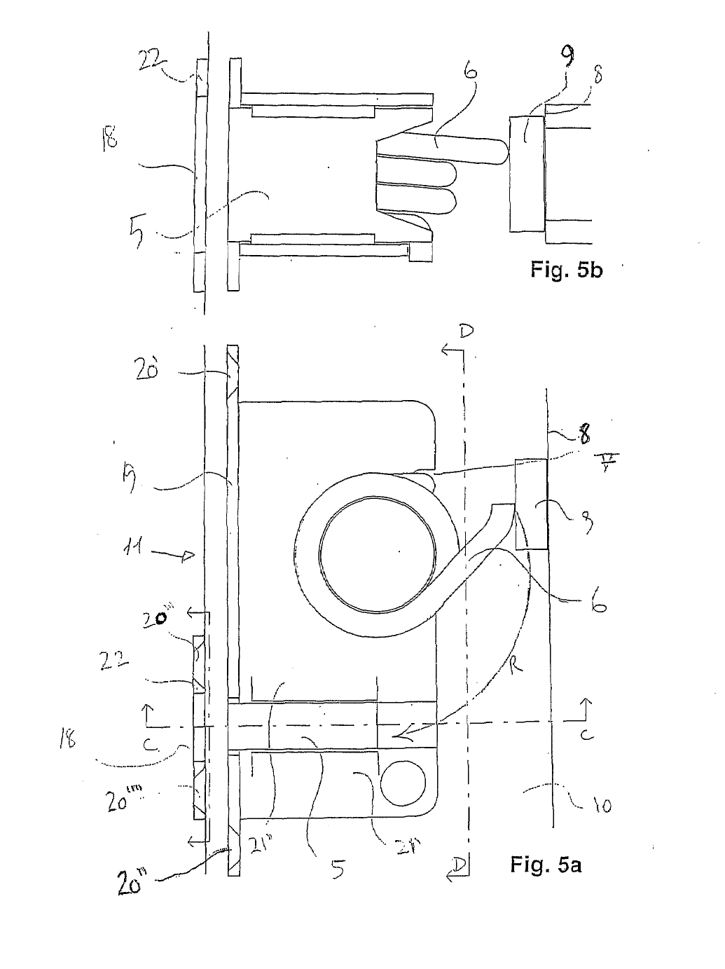

FIG. 5a shows a securing unit 11 according to the invention arranged in the window frame 10. The securing unit 11 is positioned behind a cover plate 19 attached with screws 20′, 20″. The actuator 6 is a spring positioned so that it exerts a pressure against the pane edge 8. Between the actuator 6 and the pane edge 8 a plate 9 is positioned to protect the pane and distribute the pressure from the actuator 6 along the pane edge 8. The plate 9 is preferably made from a plastic material. If the window pane is broken, the pane cannot exert a pressure against the actuator 6, whereby the actuator 6 forces the pane edge 8 to move so that the actuator 6 actuates rotating along arrow R thereby forcing the slidable rod 5 from its unlocked position between guiding plates 21′, 21″ to it's locked position in the recess 18 in the stationary window frame. When the slidable rod 5 is positioned in the locked position the window is blocked from being opened. The receiving means 18 is preferably reinforced with reinforcing plate 22 attached through screws 20′″, 20″″.

FIG. 5b shows the securing unit seen from a section C-C, and FIG. 5c shows the securing unit seen from section D-D both in the direction of the arrows in FIG. 5a.

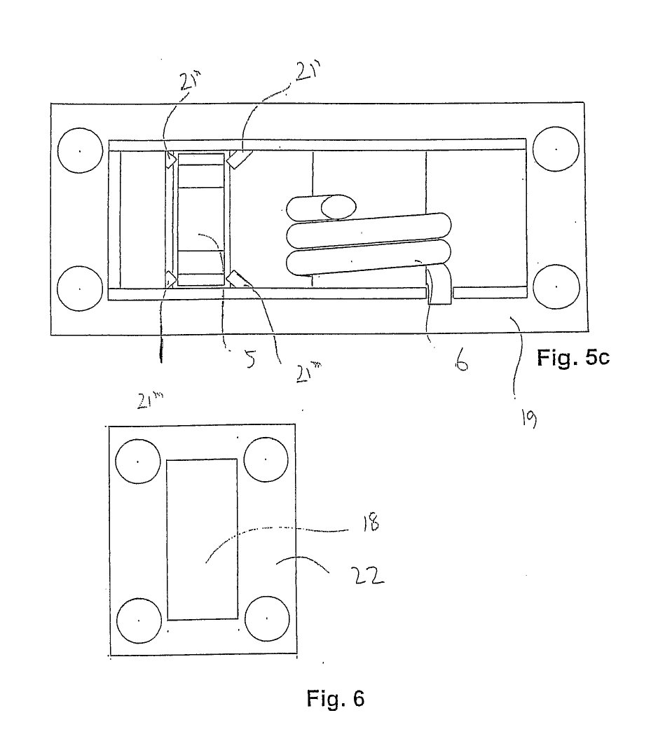

FIG. 6 shows a reinforcing plate 22 for securing receiving means 18 in the stationary window frame of FIG. 5.

FIG. 7 shows a securing unit for use in a window assembly as shown in FIG. 1d that is wherein breakage of a neighbouring window may lead to the openable window to be blocked. The actuator is arranged as described in any of the other embodiments herein. The actuator forces an intermediary locking means 23 arranged in the stationary window frame 16 of a neighbouring window to force locking means 5 into the receiving means 18 in a window frame 10 of a neighbouring window thereby blocking the neighbouring window from being opened. The receiving means 18 is reinforced by reinforcing plate 22.

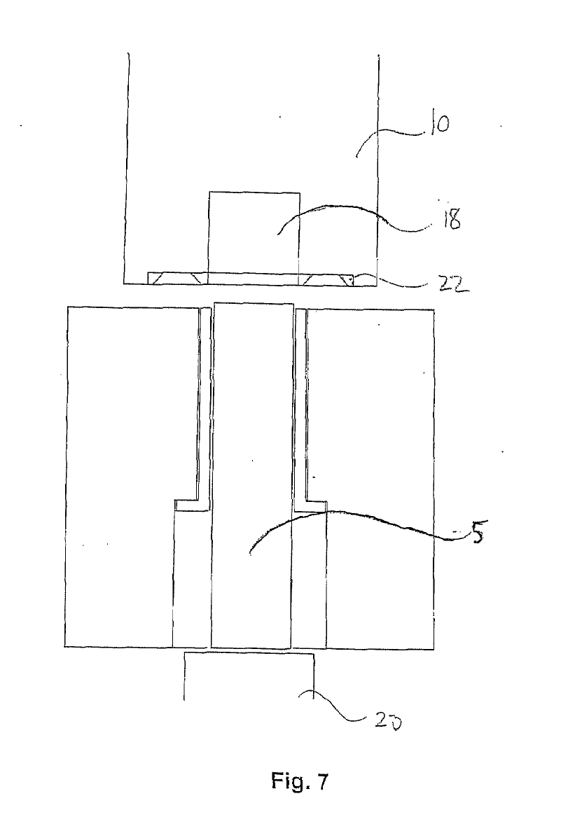

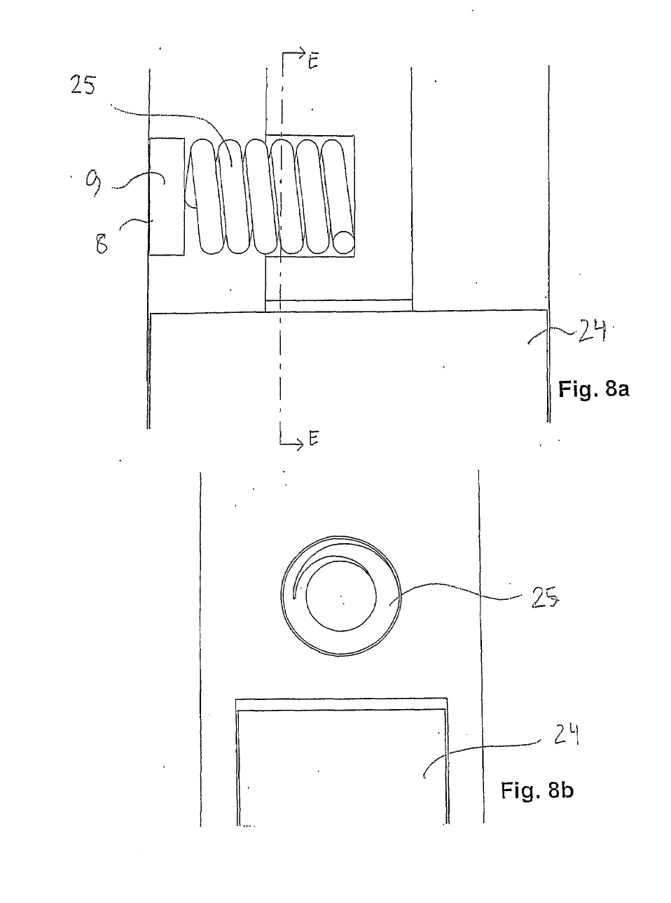

FIG. 8a shows an auxiliary actuator 25 arranged adjacent the unit house 24. The auxiliary actuator 25 presses against the pane edge 8 through plate 9. If the window pane is broken then the pane cannot exert a pressure against the auxiliary actuator 25, whereby the auxiliary actuator 25 forces the pane edge 8 to move so that the actuator in the unit house 24 can actuate. FIG. 8b shows the auxiliary actuator seen from section E-E in FIG. 8a.

FIG. 9a shows a securing unit 11 according to the invention arranged in a lampoon in the window frame 10. The lampoon comprises lampoon rod 1, pawl 2 as well as hub 3. The actuator is a spring positioned below locking means 5 so that it exerts a pressure against the pane edge 8. Between the actuator and the pane edge 8, a part of the locking means 5 is positioned to exert the function of a protection plate as discussed above. This part of the locking means 5 is connected to the locking means 5 in a manner so that when the actuator is actuated it extends thereby dragging the locking means 5 so that the rectangular recess of the locking means 5 locks the hub 3 thereby blocking the window from being opened. The window further comprises a lampoon and lampoon rod 1.

FIG. 9b shows the securing unit of FIG. 9a seen from section C-C.

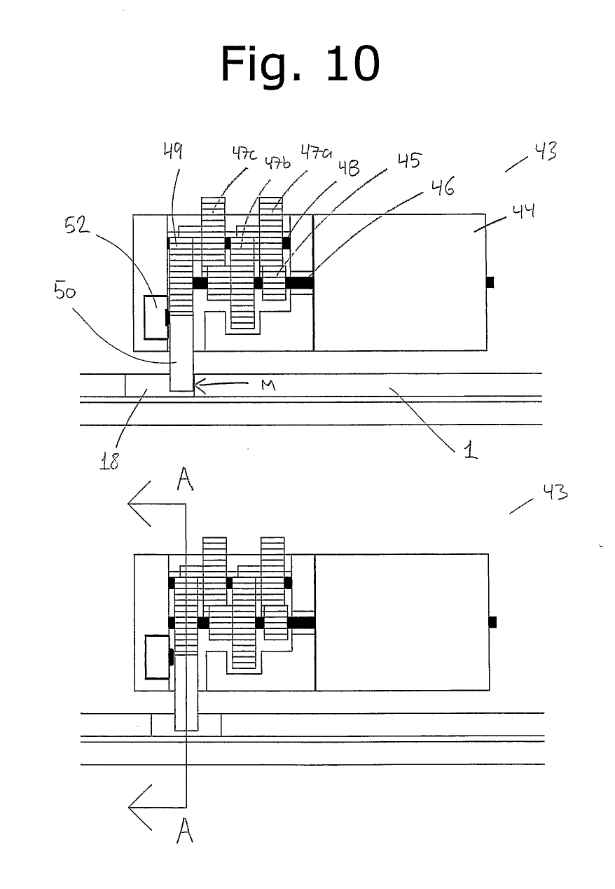

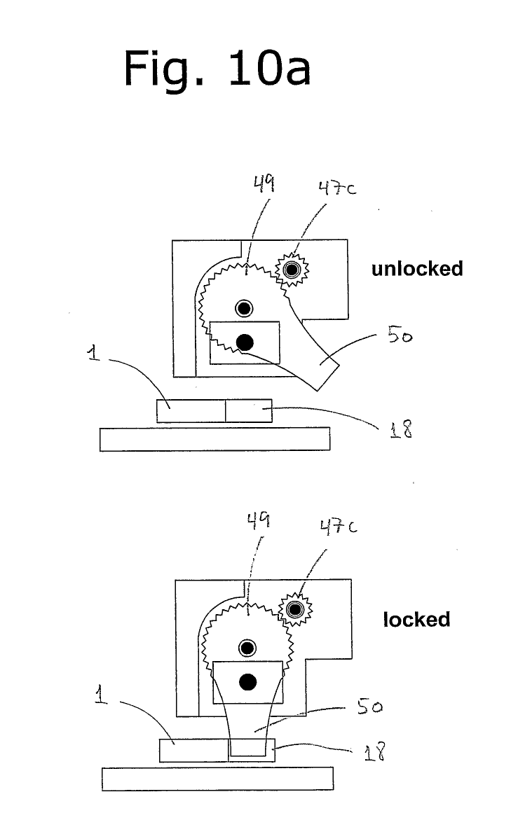

FIG. 10 shows the motor-gear-lock with detector (43) (FIG. 10) consists of a DC-motor 44 with a gearwheel 45 fastened to the motor shaft 46. The gearwheel 45 drives 3 similar gearwheels 47a, 47b and 47c, all free to turn and not fastened to the motor shaft 46 and the shaft 48. The last gearwheel 49 is driven by the small gearwheel 47c and is also free to turn and not fastened to the motor shaft 46. When the DC-motor is power for a very short time under 0,1 second the blocking rod 50 that is a part of gearwheel 49, is moved into the receiving means 18. Now the lampoon rod 1 is in a locked position. In some drawings the receiving means is described as a reinforcing plate 22.

When the intruder makes an attempt to break up the window or door, e.g. by use of a screwdriver 51 or break a pane and makes an attempt to turn the handle, by intention to open the window or door, a movement of the rod in direction M will make a pressure on the blocking rod 50 that will move into the micro-switch 52 that result in an activation.

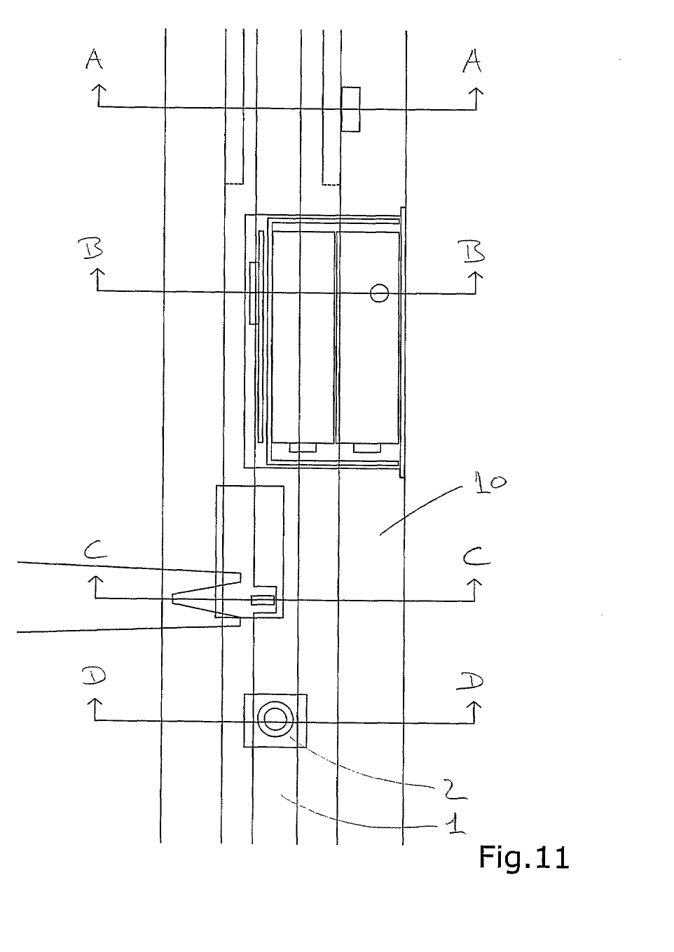

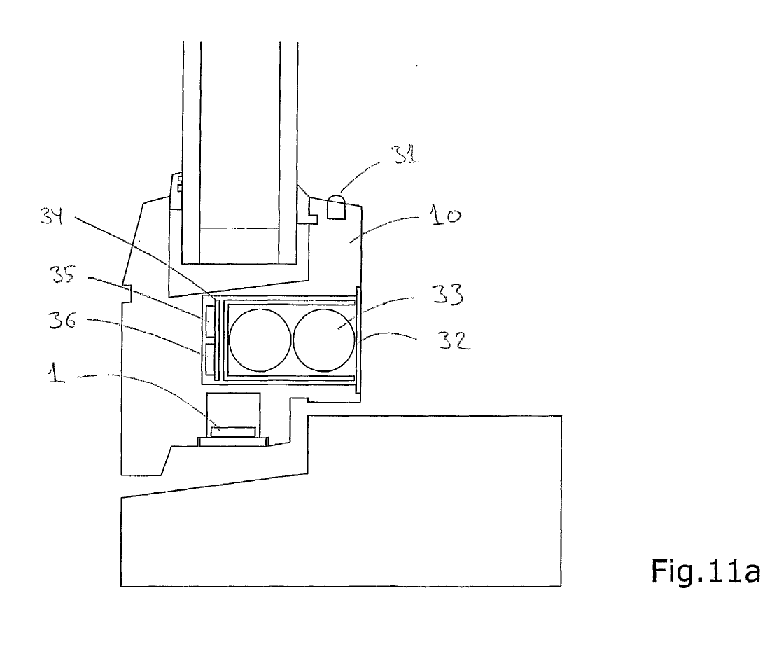

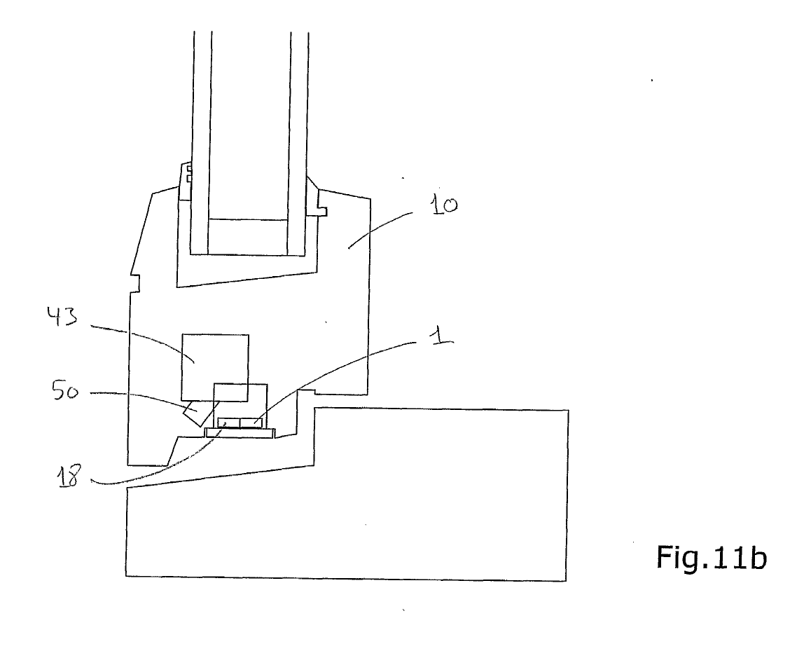

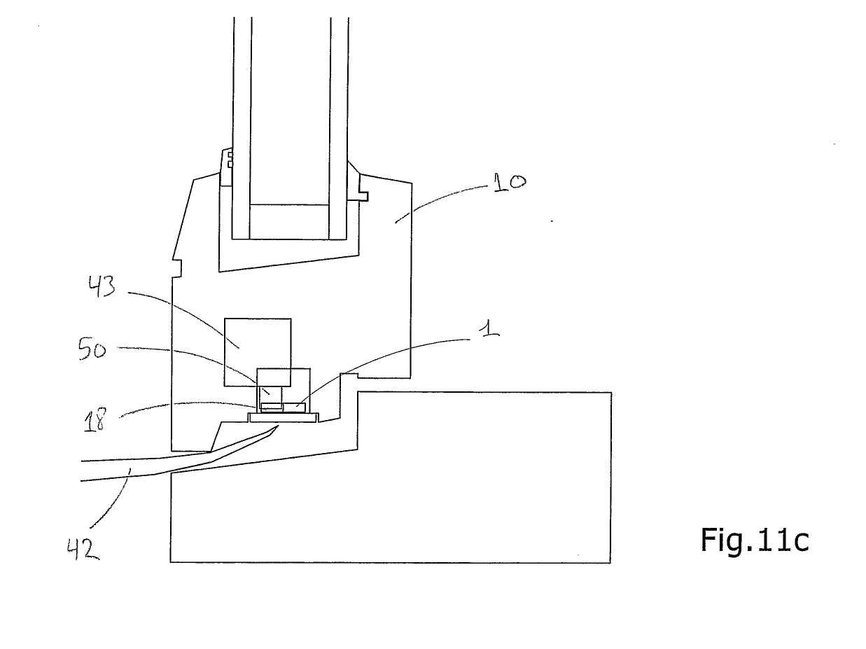

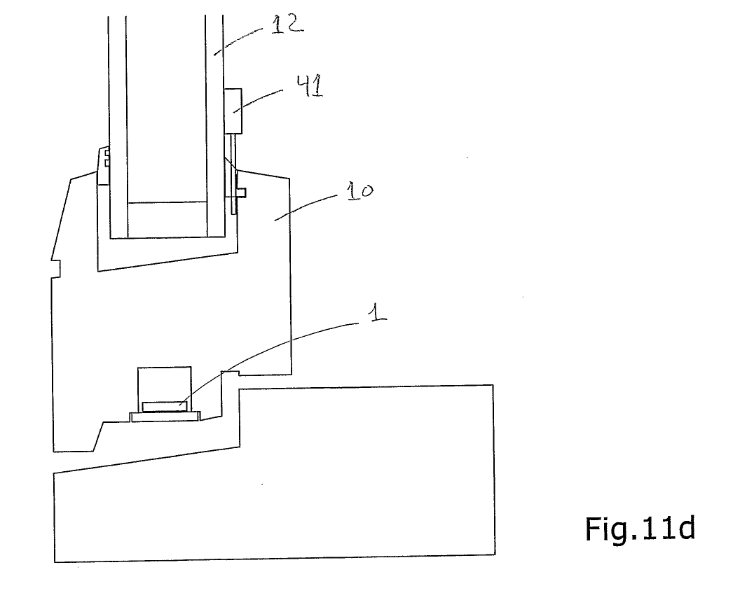

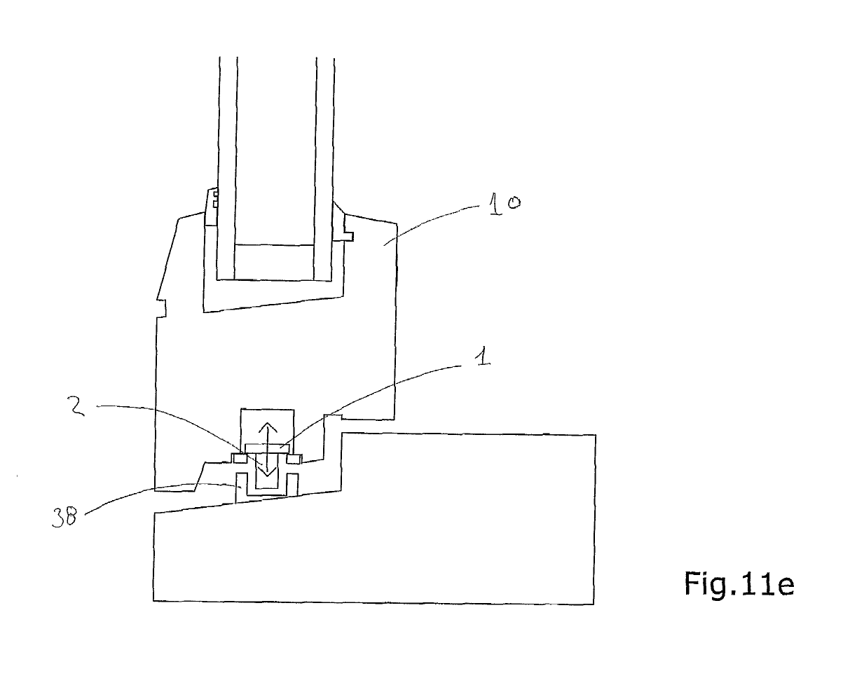

In the following FIGS. 11-16 are described. Product A is a product integrated during production, whereas product B is a product mounted after production.

In one embodiment the system consists of a product A1 (FIG. 11) that is integrated in the window/door frame in windows/doors whit an opening-function based on a lampoon rod (1) with non sliding pawls or locking means equal to that. Product A1 is integrated into the frame during the production of the window/door.

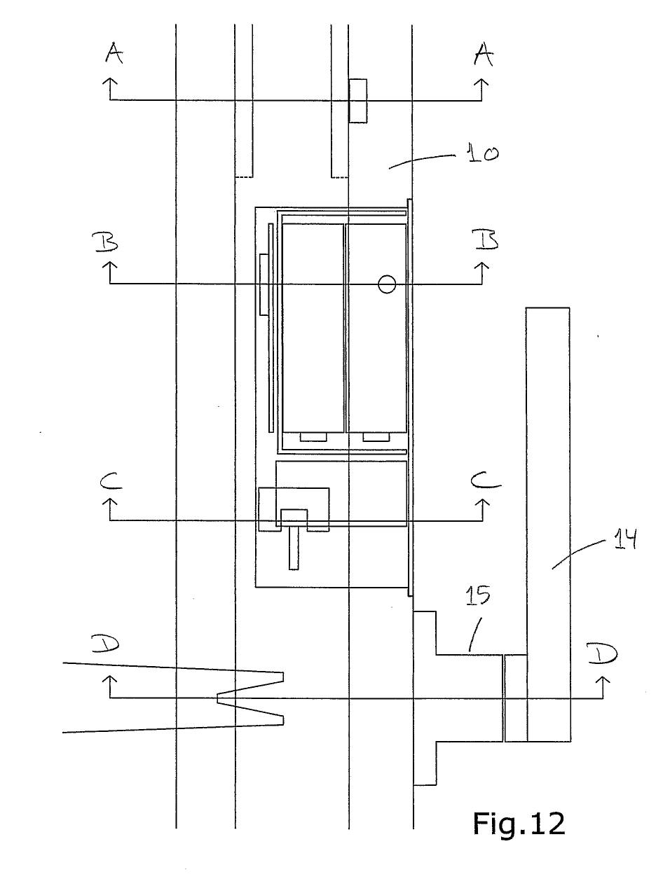

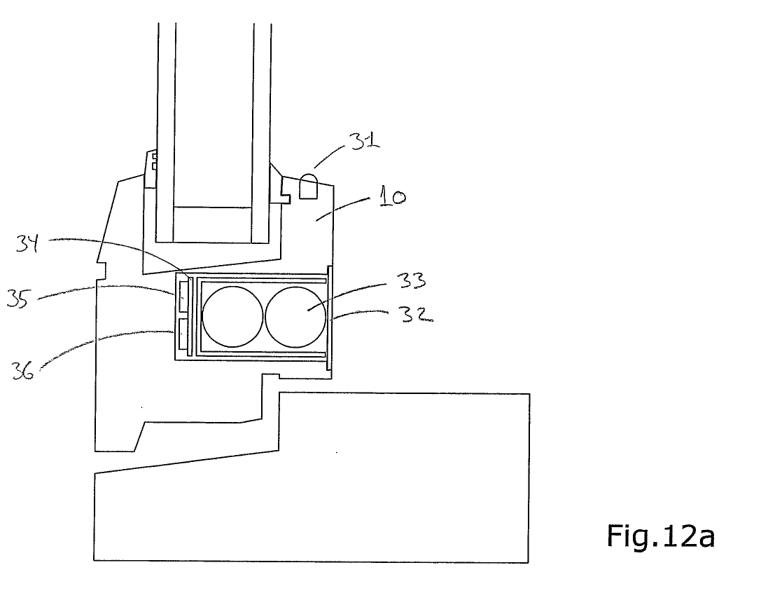

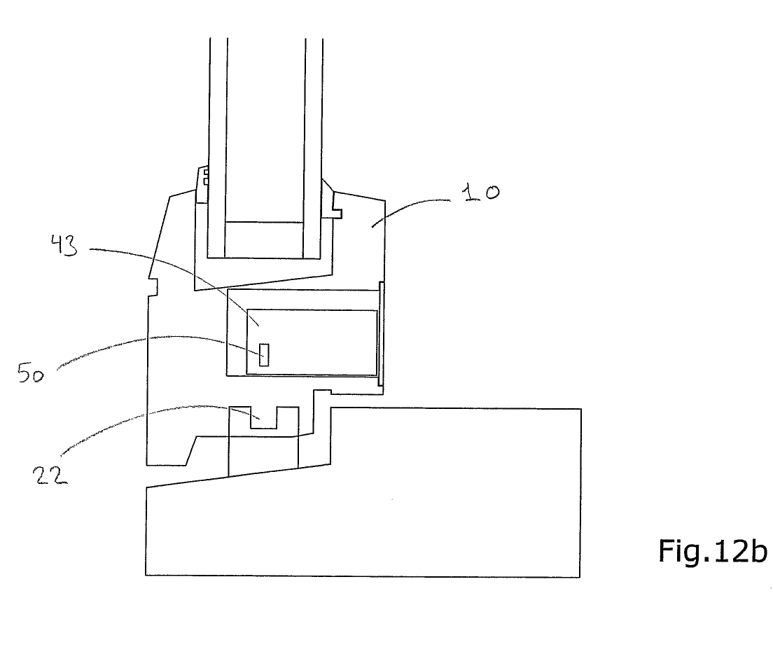

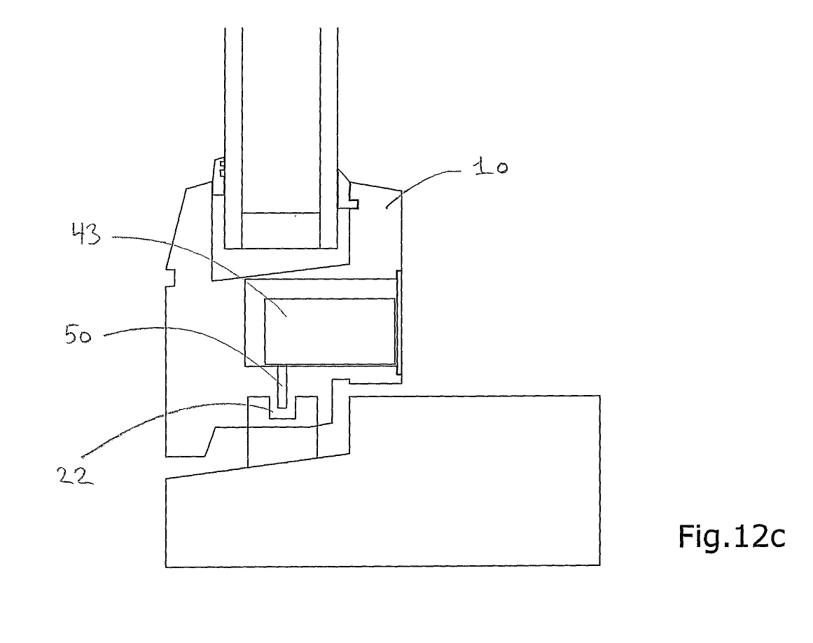

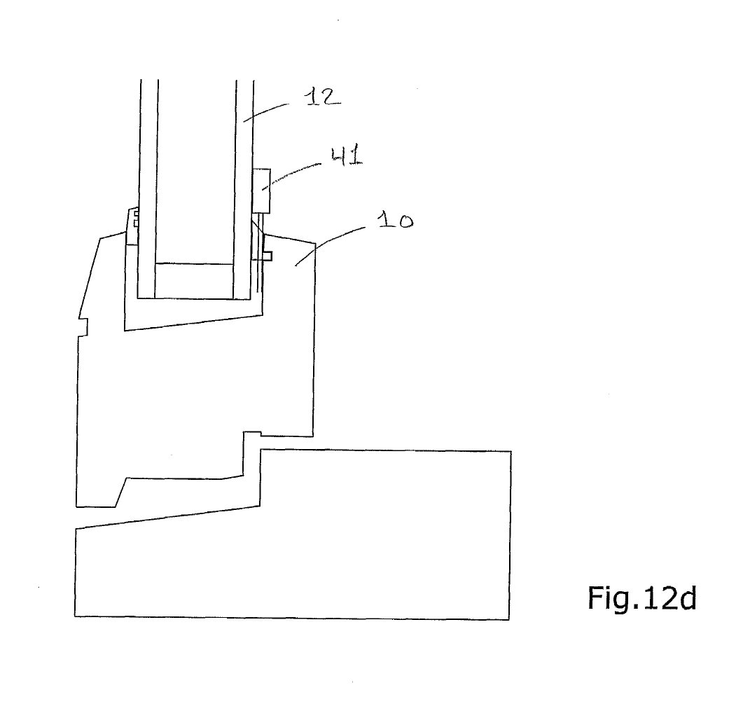

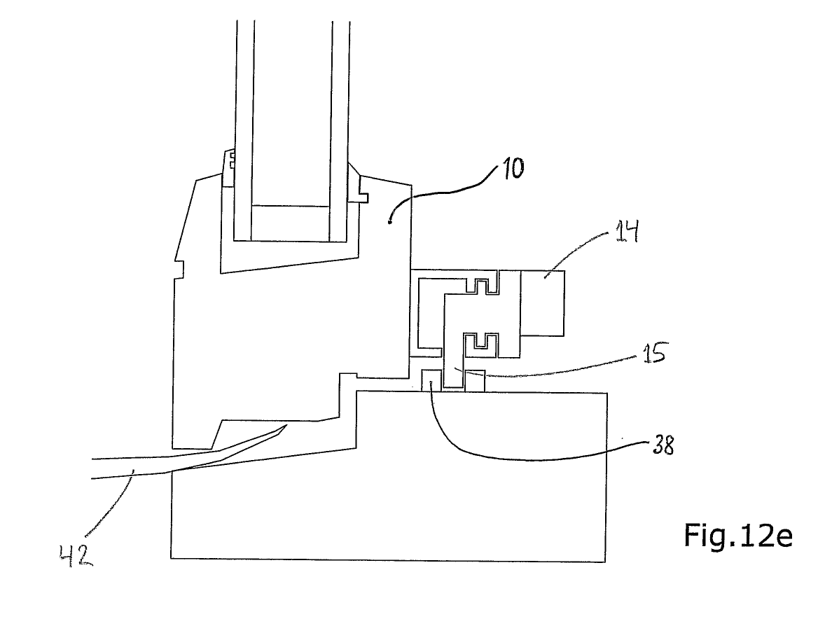

In another embodiment the system consists of a product A2 (FIG. 12) that is integrated in the window/door frame in windows/doors whit an opening-function based on a fastener (15) locking means not equipped with lampoons. Product A1 A2 is integrated into the frame during the production of the window/door.

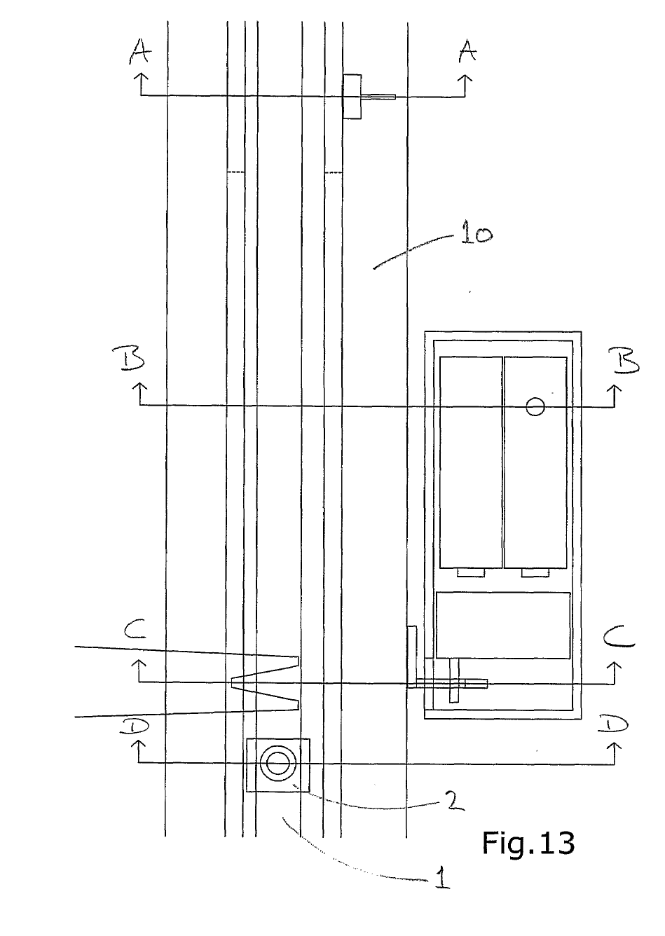

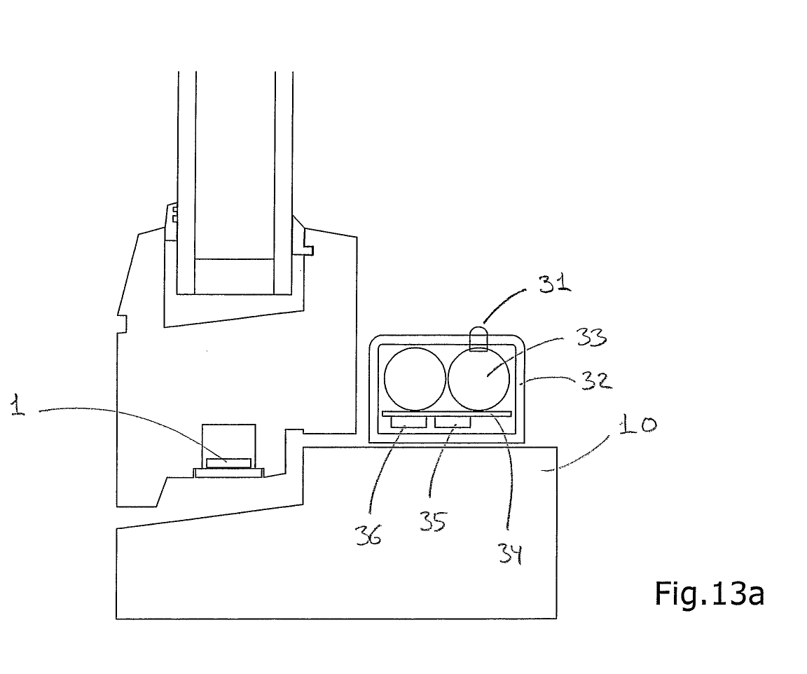

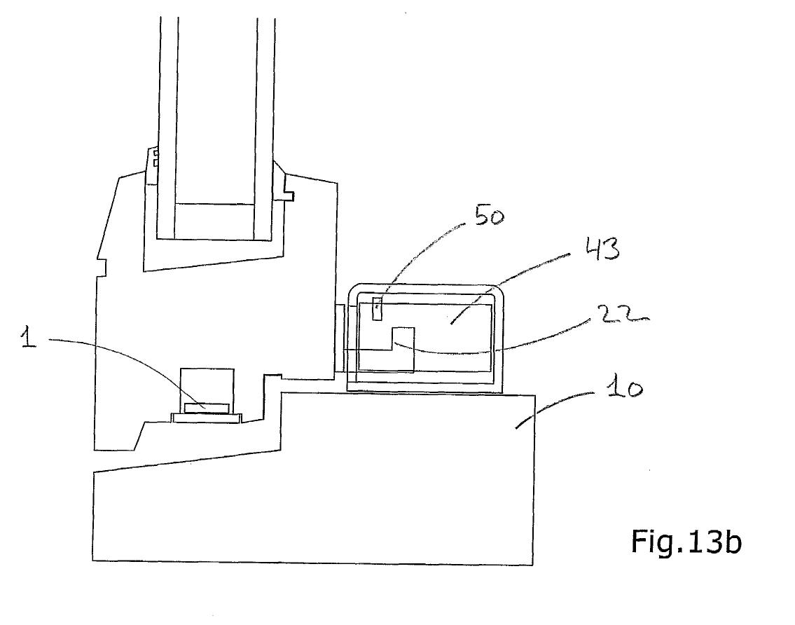

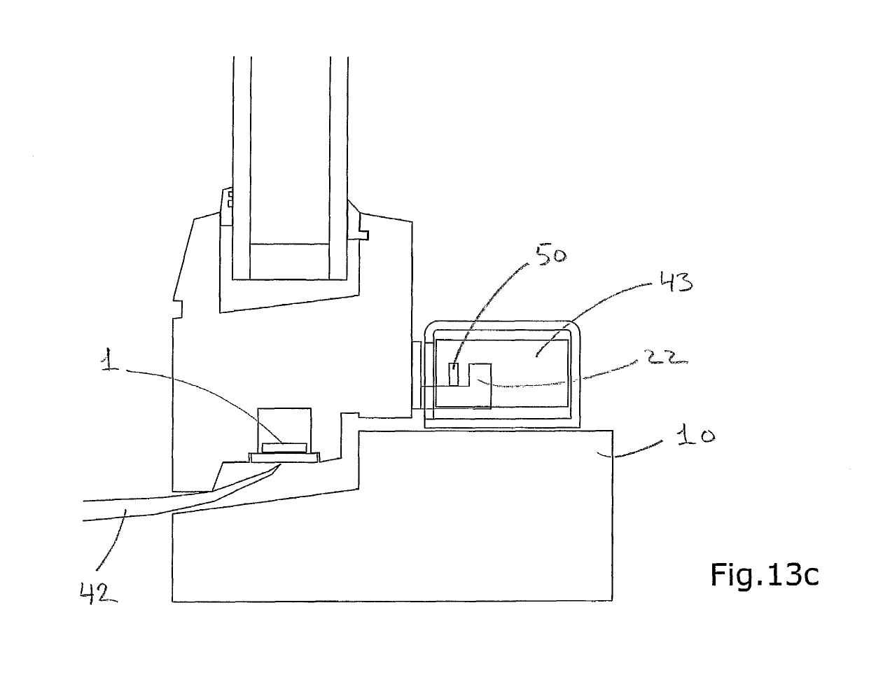

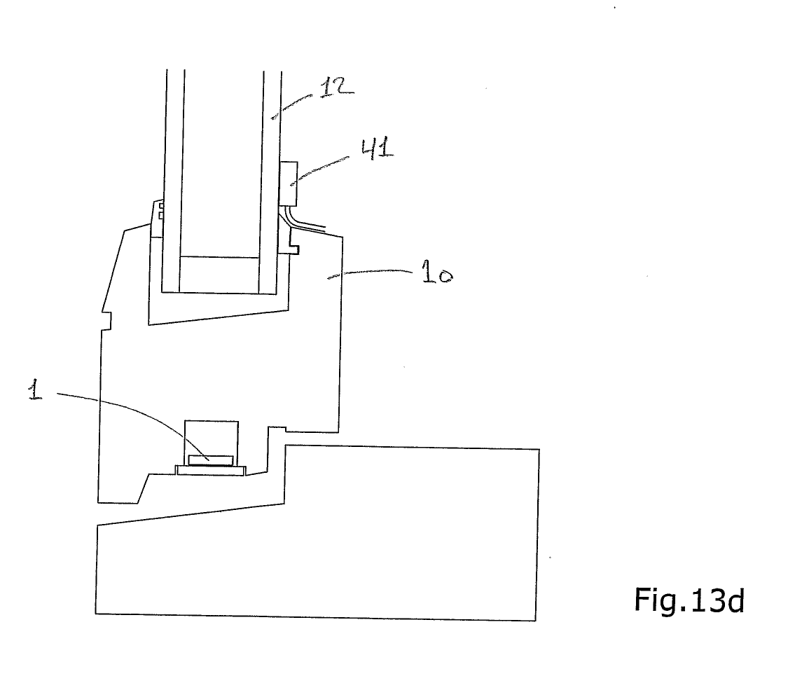

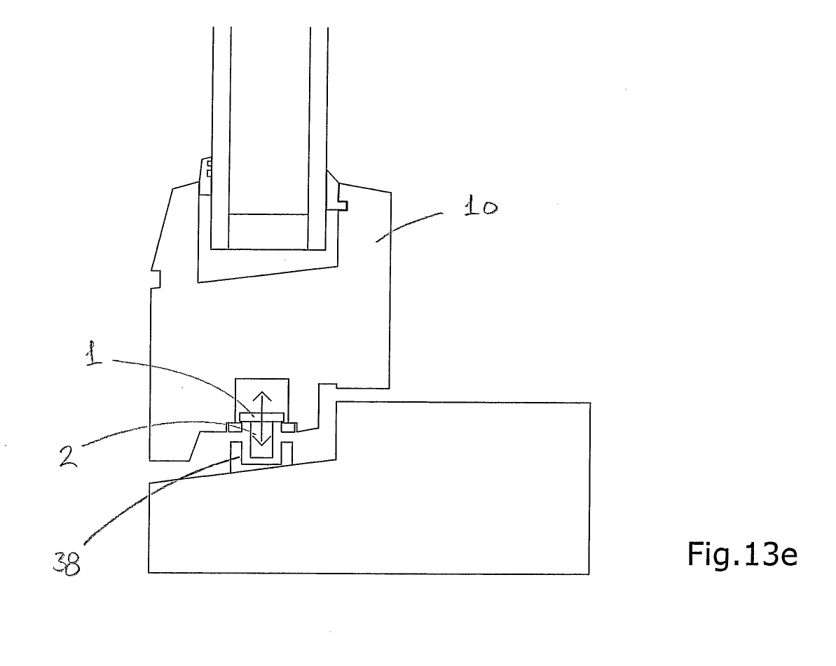

In a third embodiment the system consists of a product B1 (FIG. 13) that can be mounted into the frame of the window or door after production of the window or door itself. The product B1 is built into a unit house (32). The product B1 can be mounted into every type of window or door irrespective of the type of locking system. FIG. 13 shows product B1 based on a lampoon rod (1) with non sliding pawls or locking means equal to that.

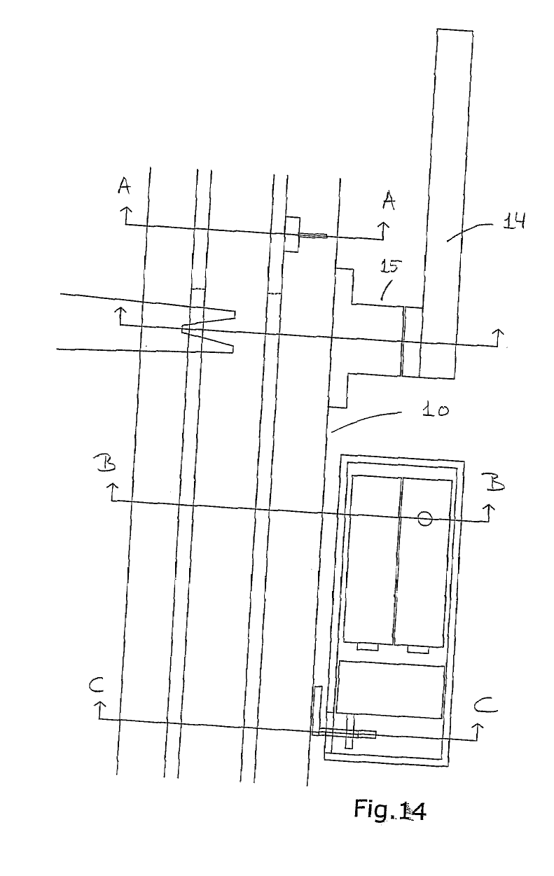

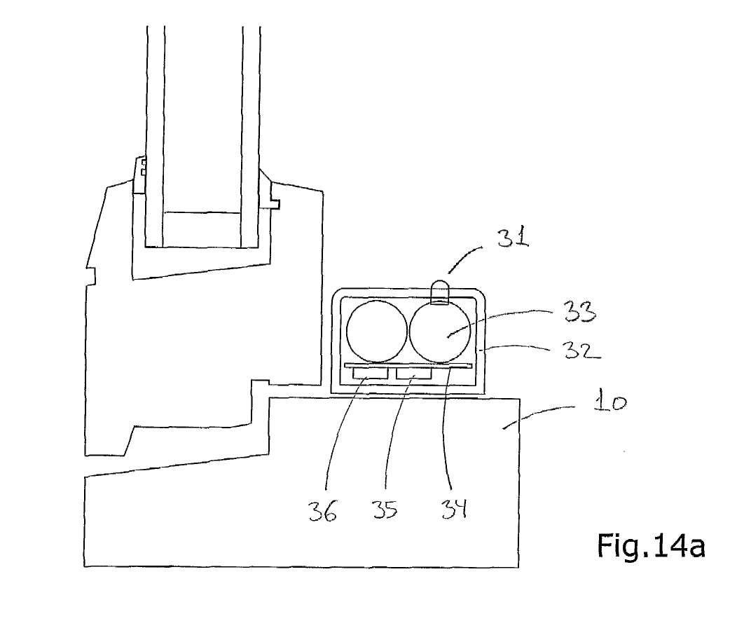

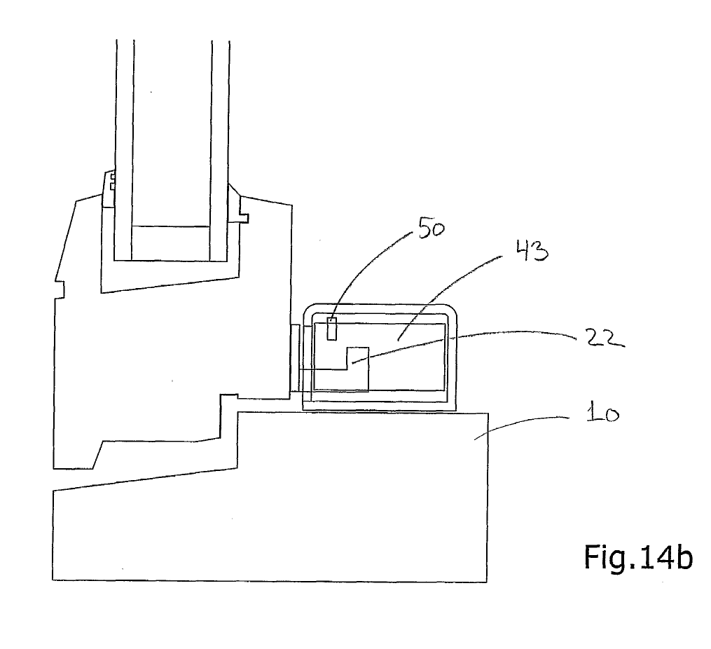

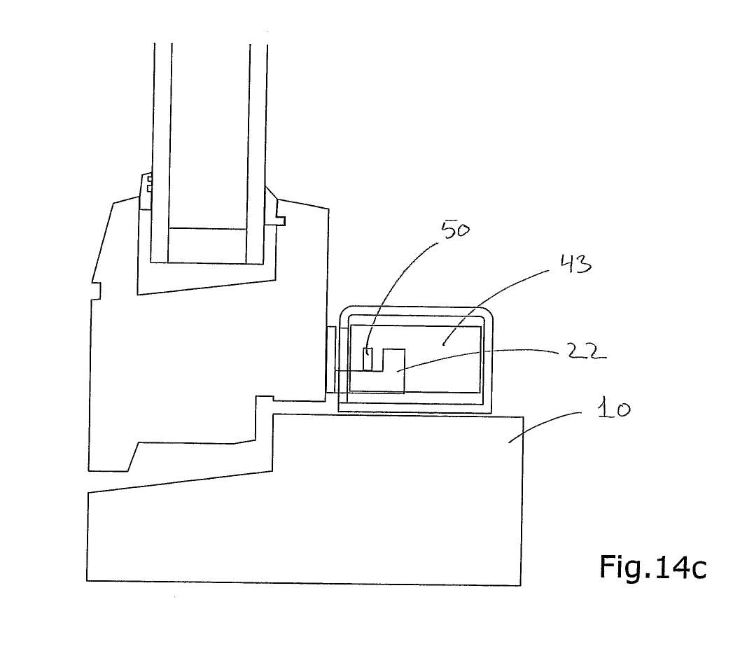

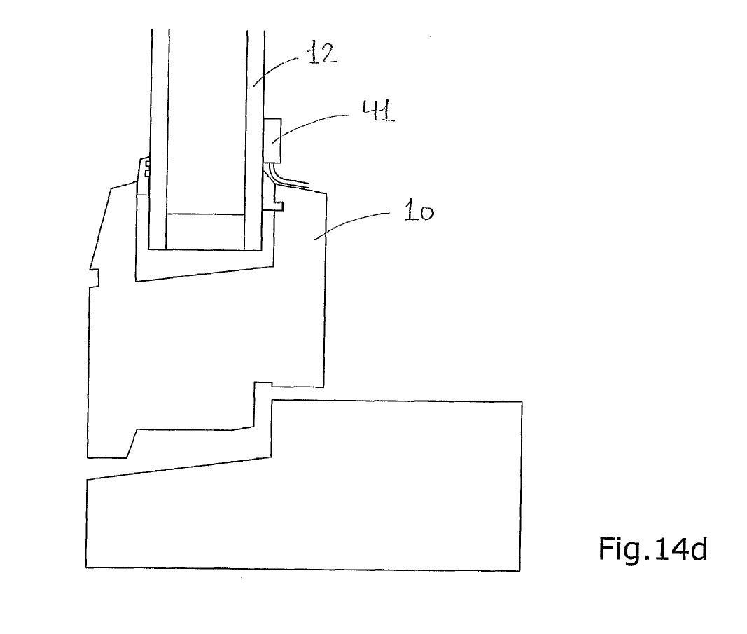

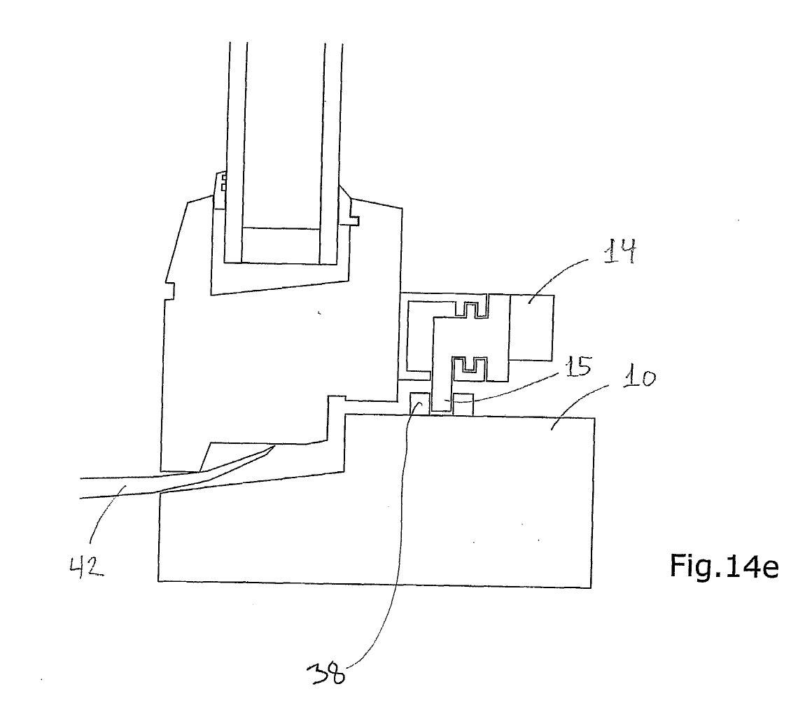

In a fourth embodiment the system consists of a product B2 (FIG. 14) mounted into the frame of the window or door after production of the window or door itself. The product B2 is built into a unit house (32). The product B2 can be mounted into every type of window or door irrespective of the type of locking system. FIG. 14 shows product B2 based on a fastener (15) locking means not equipped with lampoons.

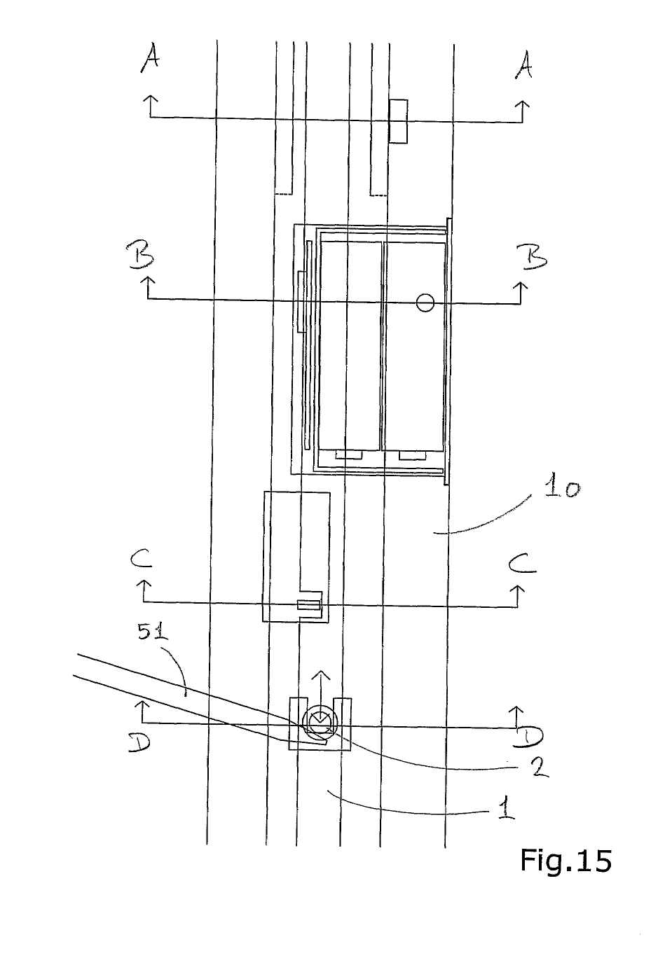

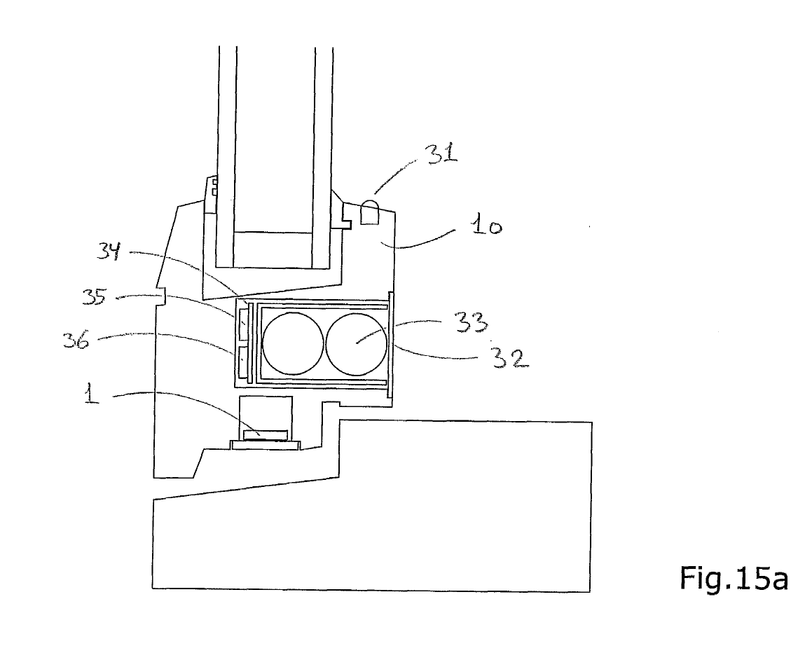

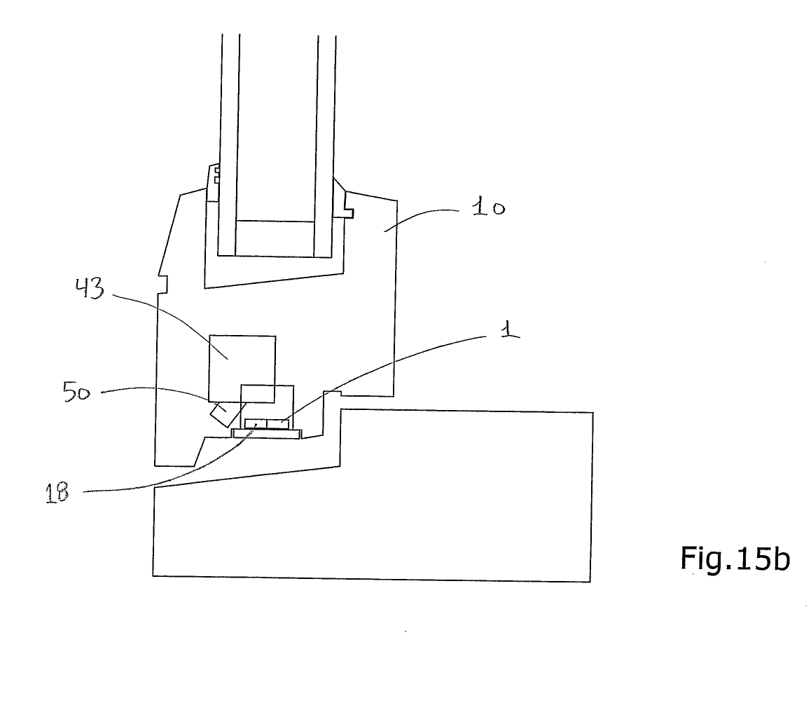

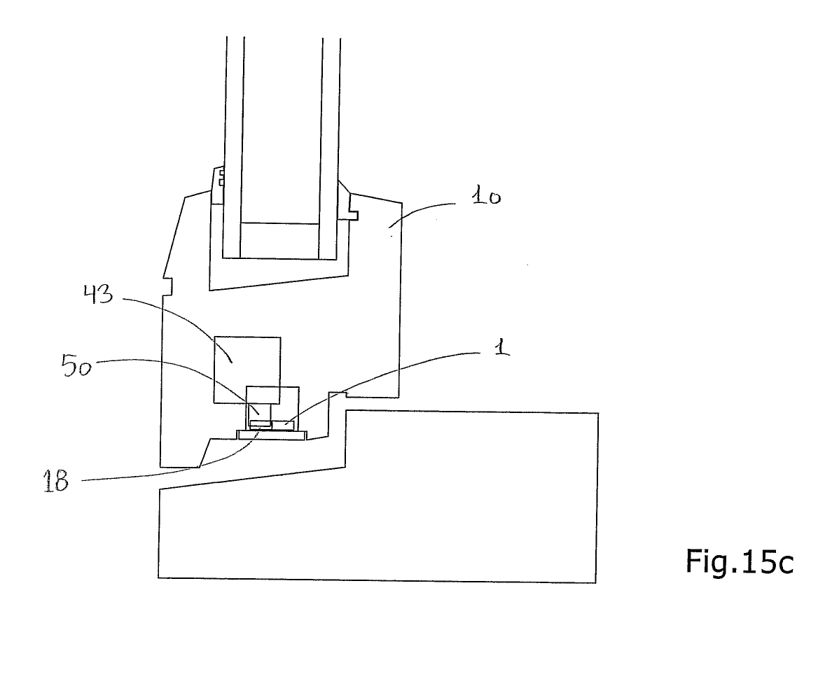

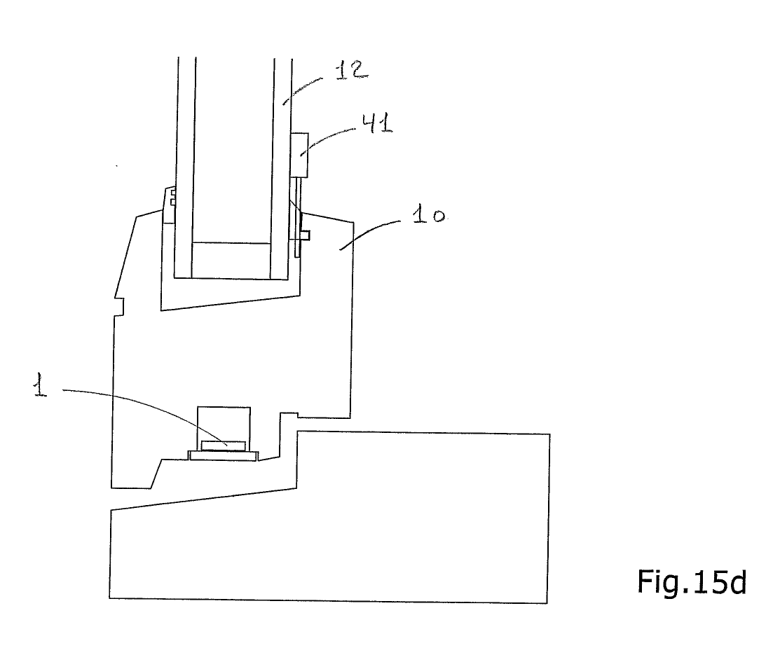

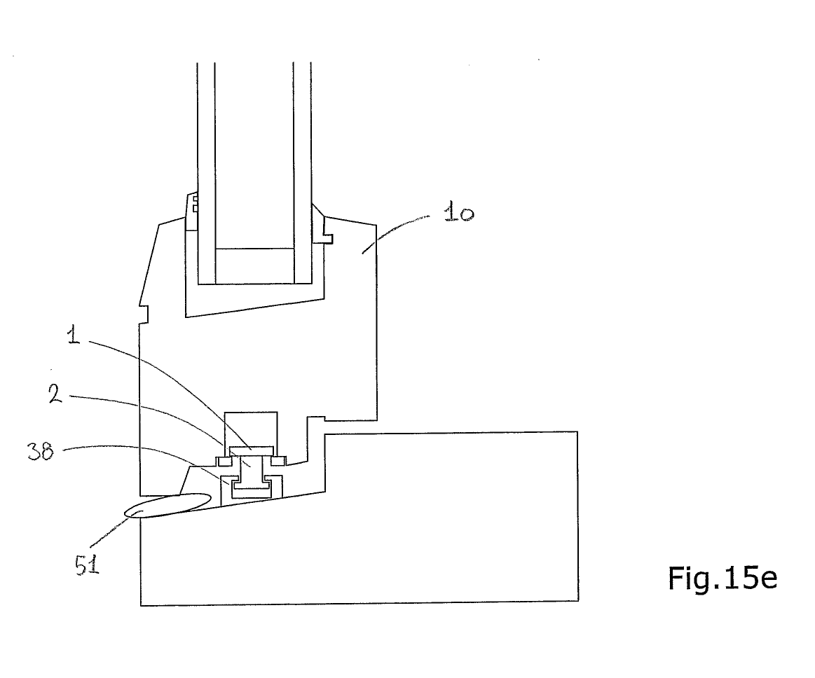

In a fifth embodiment the system consists of a product A3 (FIG. 15) that is integrated in the window/door frame in windows/doors with an opening-function based on a lampoon rod (1) with sliding pawls or locking means equal to that. Product A3 is integrated into the frame during the production of the window/door.

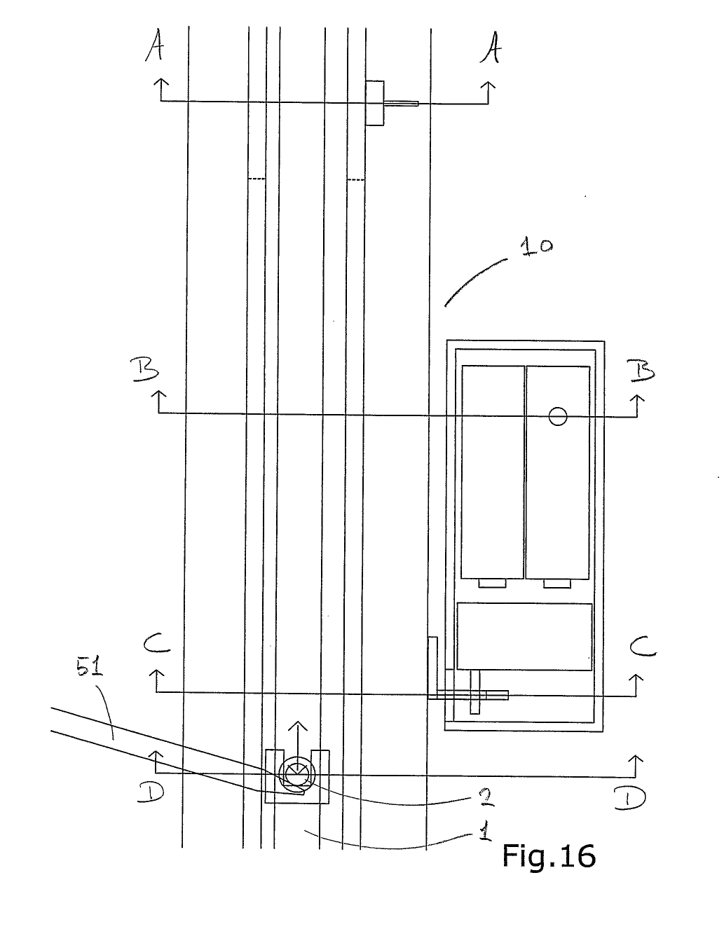

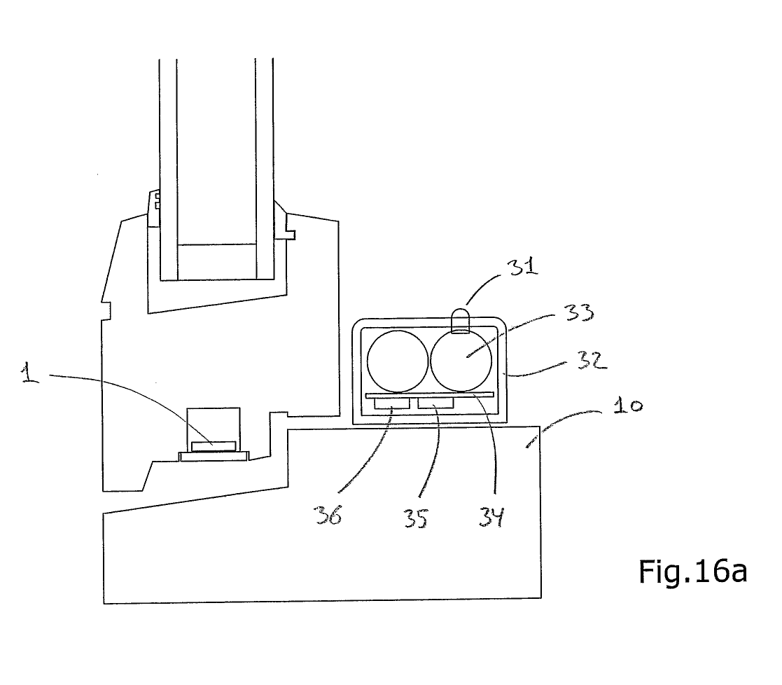

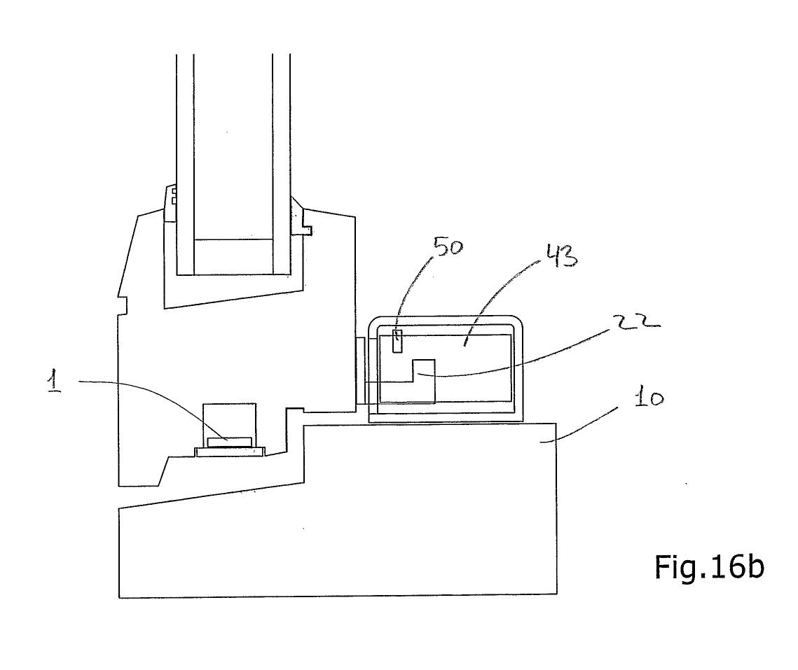

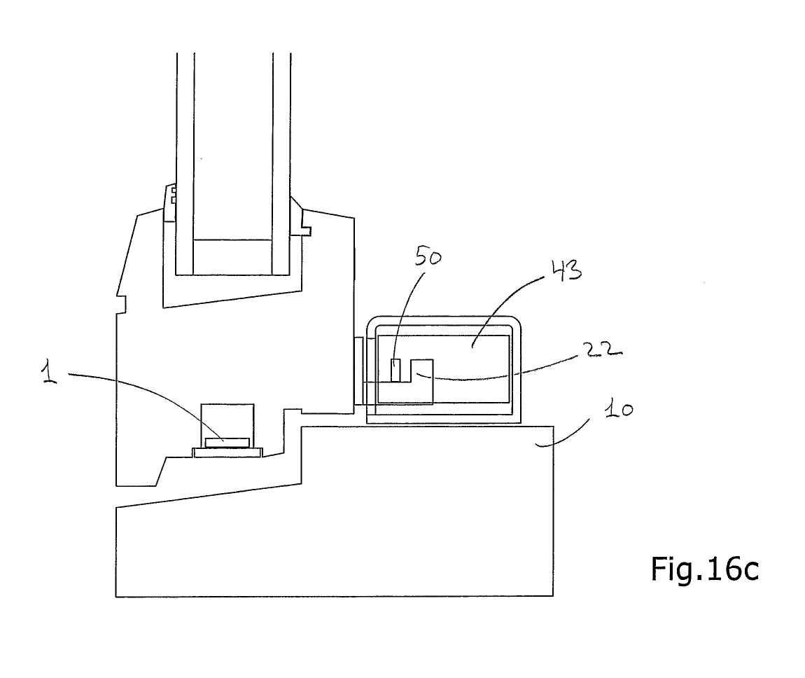

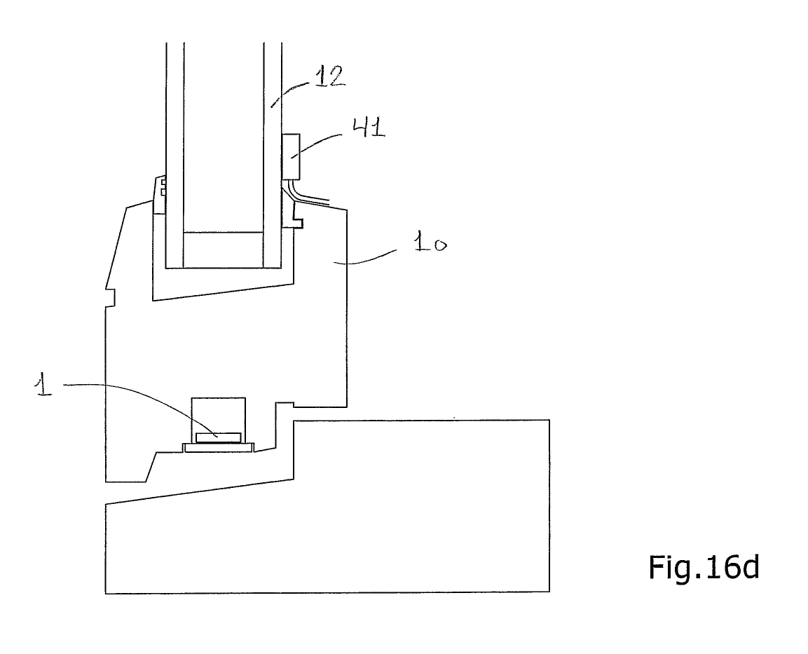

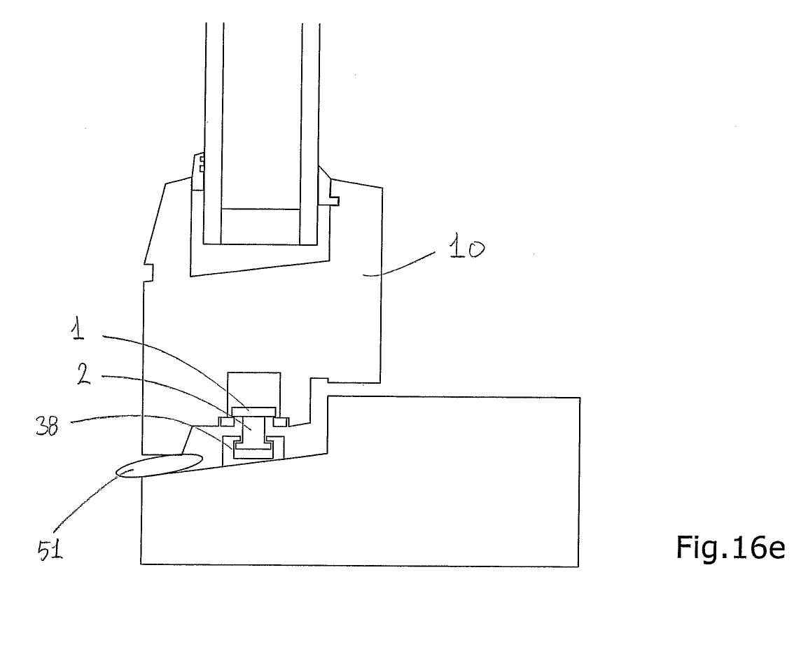

In a sixth embodiment the system consists of a product B3 (FIG. 16) that can be mounted into the frame of the window or door after production of the window or door itself. The product B3 is built into a unit house (32). The product B3 can be mounted into every type of window or door irrespective of the type of locking system. FIG. 16 shows product B3 based on a lampoon rod (1) with sliding pawls or locking means equal to that.

A part of product A1 (FIG. 11a), A2 (FIG. 12a), A3 (FIG. 15a), B1 (FIG. 13a), B2 (FIG. 14a), B3 (FIG. 16a) (view along B-B) is visible to the user and from outside. In darkness by means of a LED (31).

Another part of product A1(FIG. 11a) A2(FIG. 12a) A3(FIG. 15a) B1(FIG. 13a) B2(FIG. 14a) B3(FIG. 16a) (view along B-B) is a battery power supply (33).

A third part of product A1 (FIG. 11a) A2(FIG. 12a) A3(FIG. 15a) B1(FIG. 13a) B2(FIG. 14a) B3(FIG. 16a) (view along B-B) is electronic circuit (34) primaries consisting of a radio transmitter (35) that can sent and receive radio signals and a microprocessor (36). The microprocessor is connected to all the units in product and decides what has to take place in case of an order.

A forth part of product A1 (FIG. 11b, 11c) A2(FIG. 12b, 12c) A3(FIG. 15b, 15c) B1(FIG. 13b, 13c) B2(FIG. 14b, 14c) B3(FIG. 16b, 16c) (view along C-C) is an motor-gear-lock with detector (43). In product A1 and A3 it can accomplish a blocking of the lampoon rod (1) or locking means equal to that. The result is that the opening function is not possible. In product A2, B1, B2 and B3 it can also accomplish a blocking function. The blocking function is established between the blocking rod (50) on the motor-gear-lock with detector (43) and the reinforcing plate (22) mounted on the stationary frame.

A fifth part of product A1 (FIG. 11d) A2(FIG. 12d) A3(FIG. 15d) B1(FIG. 13d) B2(FIG. 14d) B3(FIG. 16d) (view along A-A) is an piezoelectric glass break detector (41) that is mounted on the pane (12).

FIG. 11e, 13e, 15e and 16e (view along D-D) shows the closing points (38) based on a lampoon rod (1) or locking means equal to that.

FIG. 12e and 14e (view along D-D) shows the closing points (38) based on a fastener method (15) or locking means equal to that.

In the following the functionality of the system is described: When the intruder makes an attempt to break up the window or door, e.g. by use of a crowbar (42) or screwdriver (51), the blocking rod (50) in the motor-gear-lock with detector (43) makes pressure on the microswitch (52) The short-circuit is registered by the micro-processor (36).

The radio transmitter/receiver (35) sends a radio signal. The radio signal is received by an accessory product C that is an acoustic alarm. Product C is activated. The intruder and the surroundings are being warned.

When a pane (12) in the window/door with an opening-function or window/door nearby is broken product D that is an acoustic glass break detector recognizes the sound picture that is produced when a pane (12) is broken. The radio transmitter/receiver (35) in product D sends a radio signal received by product C, E etc.

The detection of a pane (12) being broken could also be done by a piezoelectric glass break detector (41) that is mounted on the pane (12). When the pane (12) is broken the piezoelectric glass break detector (41) will produce an electrical power. The electrical power is registered by the microprocessor (36). The radio transmitter/receiver (35) sends a radio signal that is received by product C, E etc.

Product E is a unit that can be connected to existing alarm and security systems. Product E can send and receive radio signals. That gives the opportunity of activating the alarm and security system of burglary detected by product A1, A2, A3, B, B2, B3. Or product E can send a signal to product A1, A2, A3, B1, B2, B3 when the alarm and security system is activated by the user turning on the alarm system. Product E2 is a keyboard that can be activated and deactivate the window and door security system product A1, A2, A3, B1, B2 and B3. The keyboard must be placed outside the front door and turned on and off by a user pin-code.

Product F is a smoke alarm. Product F can send a radio signal when it detects smoke. Thereby the opening-function is prevented from being blocked.

1. A burglar-proof window assembly or door assembly of a house, such as a window or door assembly comprising at least one pane surrounded by a frame, said window or door comprising
an opening and closing mechanism of the window or door, and
at least one securing unit, said securing unit comprising
an actuator, said actuator actuating when a locking signal is forwarded to the actuator,
locking means capable of shifting between at least two positions, an un-locked position and a locked position,
wherein the locking means is arranged so that when the actuator is actuated then the actuator causes the locking means to shift from an un-locked position to the locked position in the receiving means and the window or door is blocked from being opened by use of the opening and closing mechanism of the window or door, and wherein said actuator is power supplied from a battery positioned in the securing unit.

2. The burglar-proof window or door according to claim 1, wherein the locking signal is a radio signal.

3. The burglar-proof window or door according to claim 1, wherein the locking signal is a mechanical signal.

4. (canceled)

5. The burglar-proof window or door according to claim 1, wherein said actuator actuates due to a locking signal forwarded from a central computer.

6. The burglar-proof window or door according to claim 1, wherein a locking signal is forwarded to the actuator due to activation by a user.

7. The burglar-proof window or door according to claim 1, wherein the window or door comprises receiving means capable of receiving the locking means in the locked position.

8-10. (canceled)

11. The burglar-proof window or door according to claim 1, wherein the actuator is a mechanical actuator or an electromechanical actuator.

12. The burglar-proof window or door according to claim 1, wherein the actuator comprises a microprocessor and at least one radio transmitter/receiver.

13-14. (canceled)

15. The burglar-proof window or door according to claim 1, wherein the actuator comprises a motor-gear-lock.

16. The burglar-proof window or door according to claim 1, wherein the securing unit further comprises a detector.

17. The burglar-proof window or door according to claim 1, wherein the securing unit further comprises a micro switch.

18-25. (canceled)

26. The burglar-proof window or door according to claim 1, wherein the security unit is connected to an acoustic alarm.

27. The burglar-proof window or door according to claim 1, wherein the security unit is connected to a central unit.

28. The burglar-proof window or door according to claim 27, wherein the central unit is capable of activating the actuator of other windows and/or doors than the one being broken into or attempted being broken into.

29. The burglar-proof window or door according to claim 27, wherein the central unit is connected to a smoke or fire alarm.
